(19) United States
(12) Patent Application Publication
(10) Pub. No.: US 2022/0198588 A1
(43) Pub. Date: Jun. 23, 2022

(54) COMPUTER IMPLEMENTED VISUAL REAL ESTATE COMPARISON

(71) Applicant: Quitchet, LLC, Greenville, SC (US)

(72) Inventor: Robert Mahon MORGAN, Greenville, SC (US)

(21) Appl. No.: 17/669,928

(22) Filed: Feb. 11, 2022

Related U.S. Application Data
(63) Continuation of application No. 16/155,368, filed on Oct. 9, 2018, now abandoned.
Application No. 16/155,368 is a continuation of application No. 15/056,181, filed on Feb. 29, 2016, now abandoned.
(60) Provisional application No. 62/128,845, filed on Mar. 5, 2015.

(51) Int. Cl. G06Q 50/16; H04L 51/52; G06Q 10/10; G06Q 50/00

(52) U.S. Cl. CPC G06Q 50/16; H04L 51/32; G06Q 10/1093; G06Q 50/01; G06Q 10/1095

(57) ABSTRACT

Disclosed are various aspects of computer-implemented systems and methods for comparing real estate properties. In one aspect a real estate mobile application is provisioned, wherein the application has a compare home engine. The application allows users to select listings from a database and then filter the listings based on image views, such as kitchen, bathroom, etc. The compare home engine on the real estate mobile application reads metadata or otherwise uses an image search engine or algorithm to identify and tag with metadata the images from the database. The application then displays the tagged images in an easy viewing format so that the user can more readily compare the various rooms.

### CROSS-REFERENCE TO RELATED APPLICATIONS

This is a continuation-in-part of U.S. patent application Ser. No. 16/155,368 filed on Oct. 9, 2018, entitled “Social Network Application for Real Estate,” which is a continuation-in-part of U.S. patent application Ser. No. 15/056,181 filed on Feb. 29, 2016, entitled “Social Network Application for Real Estate,” which claims priority to U.S. Pat. App. Ser. No. 62/128,845 filed on Mar. 5, 2015, entitled “Social Network Application for Real Estate,” the disclosures of which are incorporated herein by reference in their entireties.

### FIELD OF THE INVENTION

The present invention relates to a computer implemented system and method and a software application for providing visual comparison of real estate properties from databases for residential real estate transactions. Namely, generating a visual comparison by utilizing computing systems to visually identify the various rooms and align them for optimal user viewing.

### BACKGROUND OF THE INVENTION

The housing market in the United States is an essential building block for the entire economy. Large numbers of residential real estate transactions have the potential for overwhelming the entire system. This is further complicated by the fact that a large percentage of buyers are first time buyers who are unfamiliar with the details required to review in a search for and buying a house.

A number of tools have been provided to assist the buyers and sellers and their agents in attempting to target a collection of suitable houses to relevant, potential purchasers. One of the most well-known is the MLS listing with MLS standing for “Multiple Listing Service.” The MLS listing is generally a regionally based complex database of listings entered directly by real estate professionals. The database is intended to act as a trading platform to buy and sell real estate properties. When a property is on the market for sale it is added to the database and tracked through the sales transaction cycle. MLS listings are one source of information that provides data that fields real estate service sites like Zillow™, Trulia™, and AGENT.COM.

However, the MLS listing service does not assist in viewing and comparing images of rooms and other aspects of real estate rooms, such as information like room square footage or shape. There exists a need in the marketplace to automatically list in comparable format, or other easy to view comparison layout, images of real estate transactions for optimal viewing and comparison of the listings. An improved comparison of images has the ability to improve the quality of real estate transactions by improving user experience and allowing for direct comparisons of selected properties.

### SUMMARY OF THE INVENTION

The present disclosure provides comparison views of images of rooms and other aspects of real estate listings. Various aspects of hardware and software, including executing processing units, memory, and other devices may be utilized to accomplish the methods and systems herein. In one aspect a computer-implemented method for comparing real estate properties is disclosed. First, a mobile computing device is provisioned with a real estate mobile application. The real estate mobile application having a compare home engine. Wherein the compare home engine is equipped with the ability to input metadata of images as well as to execute algorithms for feature extraction and image classification. One example is content based image retrieval utilizing libraries such as Tensorflow. In the method, the user selects properties from a database such as an MLS database. The user then filters the listings by selecting or deselecting the views the user wishes to compare, for example it may be kitchen views and bathroom views only. Next, the compare home engine acquires metadata from the MLS database regarding the images. If the images are tagged with, for example, kitchen and bath the compare home engine places those photos together for transmitting to a display. If metadata or tags are absent on the images, the compare home engine may remove the view or show it is not available. In other aspects, if the metadata or tags are missing the compare home engine will execute an algorithm, such as a convolutional neural network for extracting features of the image and then use a distance calculation or compare features calculation to tag or place metadata on the images. Next, the compare home engine arranges the images for ease of viewing by the user, for example all kitchen views are side by side, along with relevant statistics such as square footage or shape. Lastly, the images are displayed on a mobile computing device executing the real estate mobile application to allow for optimal user viewing and comparison.

### BRIEF DESCRIPTION OF THE DRAWINGS

FIG. 1 schematically illustrates the operation of a social network in which a networked mobile wireless telecommunication computing device communicates with a web server which in turn communicates with one or more databases.

FIG. 2 is similar to FIG. 1, with web browsers executing on a laptop computer and a desktop computer.

FIG. 3 is a block diagram showing logic layers executing on the web server of FIG. 1 to facilitate the operation of the social network.

FIG. 3A is a block diagram showing an exemplary computer system in respect of which aspects of the present technology may be implemented.

FIG. 3B is a block diagram showing an exemplary smartphone in respect of which aspects of the present technology may be implemented.

FIG. 4-41 depicts a display screen as it appears on a mobile app.

FIG. 42 is a flow diagram of an example computer implemented method for visually comparing real estate properties within a real estate mobile application.

FIG. 43 is an illustration of an example user interface on a mobile computing device displaying steps in a method for visually comparing real estate properties within a real estate mobile application.

FIG. 44 is a block diagram of an example content based image retrieval.

FIG. 45 is an illustration of an example convolutional neural network (CNN) algorithm for feature extraction.

### DETAILED DESCRIPTION

The application of this disclosure, and the many embodiments is adaptable for a plurality of users, all within a single application. The application provides for customer interface on one hand, a real estate agent on the other hand, and yet a third level for real estate managers. Further, the real estate application provisions a compare home engine and an image engine for identifying and classifying rooms of real estate listings. The applications and engines will be discussed in the following description with regard to the above entities in the same order. In all five categories, the application searches MLS database for residential real estate, which is a starting point for many users. The technology for carrying out the process of this application is described below. Generally, the real estate mobile application has the following features:

1. Compare Homes—Allows for comparing multiple homes at once on one screen with the ability to toggle between multiple comparable options including basic specs, descriptions, pictures (both posted and users), videos (both posted and users), and user notes. Further, the compare homes feature may have a compare home engine and an image engine wherein database files may be associated with metadata or tagged with the corresponding room view.

2. Check-in/out/Tracking/Safety—GPS enabled home check in/out to meet the needs of the buyer, seller, real estate agent (agent), and broker-in-charge (BIC)/office as well as safety features. In an embodiment, a map program leads the user to a home which then allows the showing agent to “check-in”.

a. Buyer

i. Check in—When the buyer checks-in at the home, this can be done at any time, they are capable of adding additional notes/pictures/videos to their home to further develop necessary information to drive a purchasing decision.

ii. Check out—When the buyer checks-out at the home, optionally controlled by the showing agent's check-out, they are prompted to provide feedback through an optionally immediate on screen feedback form unique to the app. 1) It reminds the buyer to update their rating and comments while the showing is fresh on their mind. 2) It helps provide beneficial feedback to the real estate agent AND/OR seller. 3) Prompt the buyer if they need directions to the next scheduled appointment/home.

b. Seller

i. Check in—Feature that allows the seller to know when the scheduled showing appointment has begun as it notifies the seller through text/email (their choice) when the buyer/agent check-in. The seller features are controlled by the MLS/listing agent setting up the notifications for check-in, check-out and/or neither.

ii. Check out—Feature that allows the seller to know when the buyer and agent have finished their showing appointment. The seller will receive instant notification through text/email (their choice) when the showing has completed at their listed home after the buyer/agent check-out. This can be GPS enabled through GEO Boundary Technology, but it is optionally controlled by the showing agent manually “checking out” first.

c. Agent—Feature in place to increase schedule visibility with the intention of improved Agent safety and tracking by authorized parties.

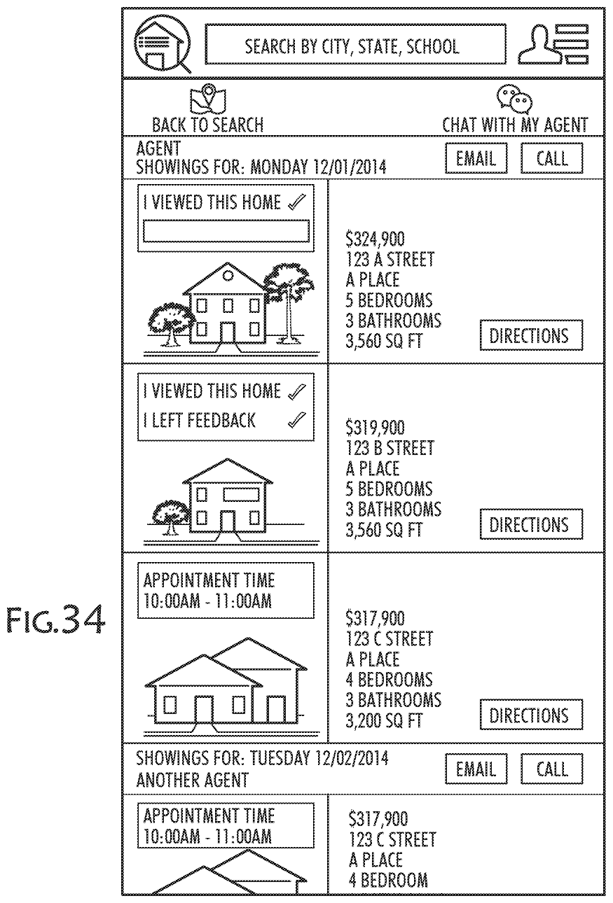

i. Check-in—Prompts dashboard on Agent's smart phone that gives them the option to access the home screen, notes/feedback, contact office, call 911, or go to home screen. Check-in also alerts BIC or designated office lead that the Agent has started his/her showing appointment. There is a countdown display that can be optionally displayed on the agent's screen (e.g. the Detail Page, referred to with respect to FIG. 34).

ii. Check-out—When the Agent leaves the home the Agent is prompted to check-out. The purpose of checking-out is to 1) Remind the Agent to obtain feedback from the buyer that they can then submit to seller 2) Alert the seller the showing is complete and the home is vacant 3) Alert the BIC/office that the Agent has completed the scheduled showing 4) Prompt the Agent if they need directions to their next scheduled showing/home. This can be automated by GEO Boundary. The check-out is part of the safety feature and could optionally require some sort of password or PIN to be entered by the agent. Additionally, this password or PIN could also be used (by being entered) to extend the pre-set time allowed in each home set up in the agent's profile.

d. BIC/Office

i. Check-in—Alerts office that the Agent has begun his/her showing and starts a timer. The timer allows the office to track how long the Agent has been at the home with the buyer. The office can adjust the settings on when to contact the Agent if the appointment has extended past the standard period (for instance, if the Agent has not checked out after one hour the office will be notified via email/alert to contact the Agent to ensure everything is ok).

ii. Check-out—Notifies the office that the agent has ended his/her scheduled showing.

3. Home Linked Communication—One source of communication between the app users and/or Agents separated into different files for each home in conversation. File can contain all previous conversations/pictures/videos/notes/calendar history will also connect with the user's calendar to link scheduled showings/open house to user's calendar. This revolves around photo of home and MLS number (if available.)

4. Feedback—While viewing homes the customer or agent will have a feedback screen appear or be an option on the showing screen. It will automatically ask for feedback (if GPS enabled) when checking out of a home after a showing. The agent will receive all feedback from the customer viewing the home after the buyer/user has completed feedback and checkout (this will be the listing agent if the buyer has not selected an agent). In the case of the buyer having an agent, the feedback will first be received and is editable by the agent and then can be forwarded to the listing agent or designated contact. If there are multiple showings in one day, all feedback can be sent with one button, or each can be viewed/edited and sent one at a time.

5. Communicating Appointments (Showings)—After an appointment(s) is requested which may be done through a link to a designated app source, the agent can confirm appointment(s), which will go to the “Scheduled Appointments” section of the application. Appointments will show up in the order of the scheduled appointment(s) with a time stamp of the slotted time confirmed. This screen also tracks past showings in order of the date and shows that the showing has been completed when both check-out (triggered by the check-out feature above) and feedback has been sent. The appointment will not be completed and/or time-stamped until both of the above are completed. Feedback can be completed by sending it or selecting to decline feedback. If decline, a message is still sent to the listing agent that no feedback will be provided at this time.

6. 3 Star Rating System—Measure of rating on a scale of 3 stars (1 being the lowest, 3 being the highest). This rating system can be updated through the home buying process and dictates the order or ranking of viewed homes as seen on the “Favorites” screen. This rating is visible to the buyer's agent (if he/she has selected an agent) and helps the agent understand the buyer's favorites. The buyer can also move homes up or down by sliding the listing info up or down to give them a preference order with homes of the same 3-star rating. When they select a home to “in the top 3” it will automatically replace the previously ranked 3^{rd} home on the favorite page. The rating is visible to the buyer's agent (if selected) and helps the agent understand the buyer's favorites. The agent's customer database is also ranked by 3 stars, in an embodiment. A 3-star buyer, for example, could be one that is actively/presently looking for a home.

I. Exemplary Technology

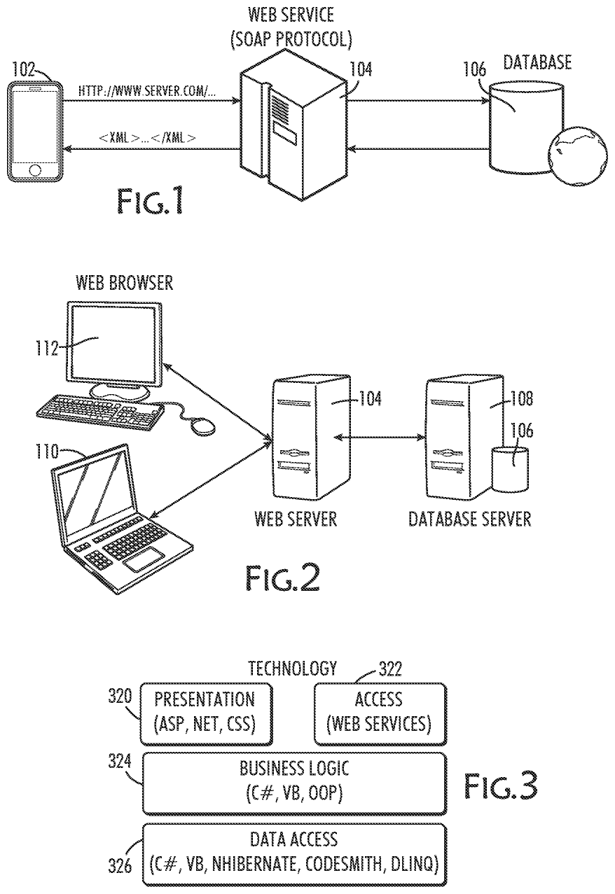

Certain aspects of the technology for carrying out the process of the current application is illustrated in FIGS. 1 through 3B. The technology for the mobile application provides a database for a web server, which is in communication through a social networking technology with the mobile application as illustrated in FIG. 1.

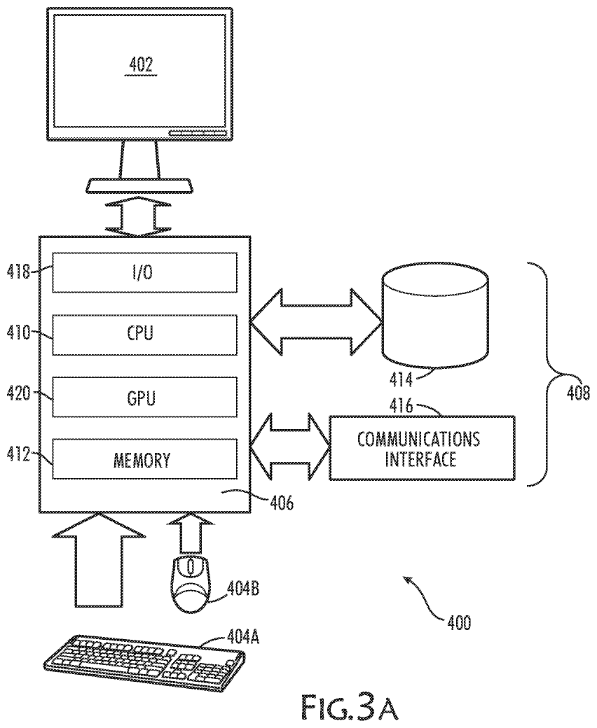

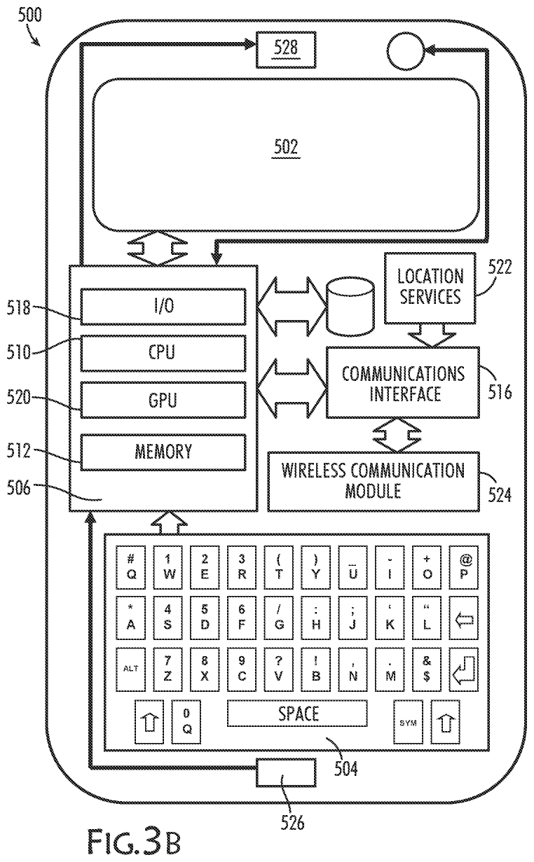

More particularly, as illustrated in FIG. 1, as an essential element of the claimed invention a networked mobile wireless telecommunication computing device, shown for illustrative purposes as a smartphone 102, communicates, e.g. via the Internet, with a web server 104 which in turn communicates with one or more databases 106 to implement the operation of a social network. The database 106 may be hosted on the web server 104, i.e. the database server and the web server may be hosted on a common computer system, or on a different computer system (e.g. a separate database server 108 as shown in FIG. 3) with communication therebetween being by way of a local area network, wide area network or the Internet, for example. In the illustrated embodiment the smartphone 102 executes the mobile application as a web application (i.e. an HTML program executing in a web browser) which sends service requests to the web server 104 using the SOAP protocol and receives responses from the web server 104 in XML (eXtended Markup Language) format for display in the web browser. Native implementations of the mobile application (e.g. for the iOS or Android operating systems) are also contemplated. FIG. 2 illustrates an arrangement similar to that shown in FIG. 1, implementing website communication with similar technology including a database server 108 implementing the database 106 and a web server 104 in communication with web browsers executing on a laptop computer 110 and a desktop computer 112.

FIG. 2 is a block diagram showing logic layers executing on the web server 104 to facilitate the operation of the social network. The logic layers include a presentation layer 320, an access layer 322, a business logic layer 324 and a data access layer 326. The access layer 322 receives web service requests (e.g. SOAP protocol requests from the smartphone 102) and passes them to the business logic layer 324 after suitable processing. The business logic layer 324 then executes on the request, typically communicating with the data access layer 326 to retrieve data from and/or store data in the database(s) 106. The business logic layer 324 can be implemented in any suitable language(s), including C Sharp (C#), Visual Basic or another suitable programming language (e.g. an object oriented programming (OOP) language). The data access layer 326 may be implemented in any suitable language(s), including C Sharp (C#), Visual Basic or another suitable programming language, or may implement tools such as NHibernate, CodeSmith, or Dlinq, for example. The presentation layer 320 presents the results from execution of the business logic layer 324, and may implement ASP (Active Server Pages), the .NET Framework, and/or Cascading Style Sheets (CSS), for example.

The present invention may be embodied within a system, a method, a computer program product or any combination thereof. The computer program product may include a computer readable storage medium or media having computer readable program instructions thereon for causing a processor to carry out aspects of the present technology. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

It will be understood that the present invention can be implemented by computer readable program instructions. Computer readable program instructions described herein can be downloaded to respective computing/processing devices from a computer readable storage medium or to an external computer or external storage device via a network. Computer readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing aspects of the mobile application described herein. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the mobile application described herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement aspects of the mobile application described herein.

An illustrative computer system in respect of which aspects of the technology herein described may be implemented is presented as a block diagram in FIG. 3A. The illustrative computer system is denoted generally by reference numeral 400 and includes a display 402, input devices in the form of keyboard 404A and pointing device 404B, computer 406 and external devices 408. While pointing device 404B is depicted as a mouse, it will be appreciated that other types of pointing device, or a touch screen, may also be used.

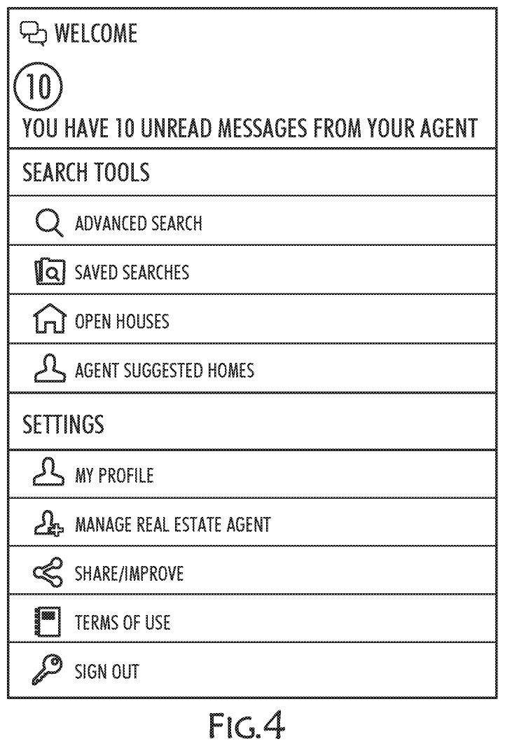

The computer 406 may contain one or more processors or microprocessors, such as a central processing unit (CPU) 410. The CPU 410 performs arithmetic calculations and control functions to execute software stored in an internal memory 412, preferably random access memory (RAM) and/or read only memory (ROM), and possibly additional memory 414. The additional memory 414 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 414 may be physically internal to the computer 406, or external as shown in FIG. 4, or both.

The computer system 400 may also include other similar means for allowing computer programs or other instructions to be loaded. Such means can include, for example, a communications interface 416 which allows software and data to be transferred between the computer system 400 and external systems and networks. Examples of communications interface 416 can include a modem, a network interface such as an Ethernet card, a wireless communication interface, or a serial or parallel communications port. Software and data transferred via communications interface 416 are in the form of signals which can be electronic, acoustic, electromagnetic, optical or other signals capable of being received by communications interface 416. Multiple interfaces, of course, can be provided on a single computer system 400.

Input and output to and from the computer 406 is administered by the input/output (I/O) interface 418. This I/O interface 418 administers control of the display 402, keyboard 404A, external devices 408 and other such components of the computer system 400. The computer 406 also includes a graphical processing unit (GPU) 420. The latter may also be used for computational purposes as an adjunct to, or instead of, the (CPU) 410, for mathematical calculations. The various components of the computer system 400 are coupled to one another either directly or by coupling to suitable buses.

FIG. 3B shows an exemplary networked mobile wireless telecommunication computing device, in the form of a smartphone 500, in respect of which aspects of the technology herein described may be implemented. The smartphone 500 includes a display 502, an input device in the form of keyboard 504 and an onboard computer system 506. The display 502 may be a touchscreen display and thereby serve as an additional input device, or as an alternative to the keyboard 504. The onboard computer system 506 comprises a central processing unit (CPU) 510 having one or more processors or microprocessors for performing arithmetic calculations and control functions to execute software stored in an internal memory 512, preferably random access memory (RAM) and/or read only memory (ROM) is coupled to additional memory 514 which will typically comprise flash memory, which may be integrated into the smartphone 500 or may comprise a removable flash card, or both. The smartphone 500 also includes a communications interface 516 which allows software and data to be transferred between the smartphone 500 and external systems and networks. The communications interface 516 is coupled to one or more wireless communication modules 524, which will typically comprise a wireless radio for connecting to one or more of a cellular network, a wireless digital network or a Wi-Fi network. The communications interface 516 will also typically enable a wired connection of the smartphone 500 to an external computer system. A microphone 526 and speaker 528 are coupled to the onboard computer system 506 to support the telephone functions managed by the onboard computer system 506, and a location services module 522 (e.g. including GPS receiver hardware) may also be coupled to the communications interface 516 to support navigation operations by the onboard computer system 506. One or more cameras 530 (e.g. front-facing and/or rear facing cameras) may also be coupled to the onboard computer system 506. The camera(s) 530 may be used to capture an image of a home or a portion of an interior of a home (e.g. a room), and/or an image of a customer and/or an image of an agent, for further handling according to the present disclosure. Input and output to and from the onboard computer system 506 is administered by the input/output (I/O) interface 518, which administers control of the display 502, keyboard 504, microphone 526, speaker 528 and camera 530. The onboard computer system 506 may also include a separate graphical processing unit (GPU) 520. The various components are coupled to one another either directly or by coupling to suitable buses.

The terms “computer system”, “data processing system” and related terms, as used herein, are not limited to any particular type of computer system and encompasses servers, desktop computers, laptop computers, networked mobile wireless telecommunication computing devices such as smartphones, tablet computers, as well as other types of computer systems.

Thus, computer readable program code for implementing aspects of the technology described herein may be contained or stored in the memory 512 of the onboard computer system 506 of the smartphone 500 or the memory 412 of the computer 406, or on a computer usable or computer readable medium external to the onboard computer system 506 of the smartphone 500 or the computer 406, or on any combination thereof.

Operation of an exemplary implementation of the mobile application will now be described.

### Exemplary and Non-Limiting Definitions

1. Customers are people who are searching for a home within a geographical area. They can search by street, city, zip code, or schools. The client has the entire suite of tools necessary for managing the searching and buying process of their new home from start to finish.
2. Real estate agents are the sellers and buyer's agent for the customers. The agent can manage all their clients, schedule appointments, chat with clients, and more within the application.
3. Real estate managers are the people responsible for overseeing agents. The application allows them to view agents checking in and check out status, receive emergency alerts and more.

II. Customer Version

The customer version is designed specifically for the end user (customer). The main focus is to give the customer one place to search, communicate with their agent, compare, rank, organize and give feedback on homes.

The home screen is the main landing page of the mobile application. Customers can access the general features by clicking on the various icons.

The application is unique in that it has a section “My Files.” The customer application is a set of features that are related to a specific home that the customer has selected from the search results. Think of this as a filing cabinet with the following built-in features and icons:

My notes

My photos

My videos

My recordings

My showings

Agent Chat/messaging

This feature allows the customer to build its own virtual file on the home(s) they are searching. These features are specific to a single home. Each home has its own file/section.

The customer version can be accessed from a website and or downloaded from iTunes or Google Market Place to the customer's mobile device (phone or tablet).

The simple search features search the MLS database based on the customer's search criteria. The simple search feature is located at the top of the application on all pages throughout the app.

The search can be based on one or more of the following:

City and State

School

Zip Code

The application searches the MLS database based on the customer's search criteria. The customer can then save the search criteria for later use. Once the user finds the home, they can add to favorites or start using these features. The following is a list of features found in the left slide out menu (or “My Quitchet” menu, specific to the Quitchet™ app), also illustrated in FIG. 4.

Features:
i. Search Tools:

Advanced search

Saved searches

Open houses

Agent suggested homes
ii. Settings:

My Profile

Manage real estate

Favorite homes

Schedule showing

Share Quitchet/Improve Quitchet

Terms of Use

Sign out

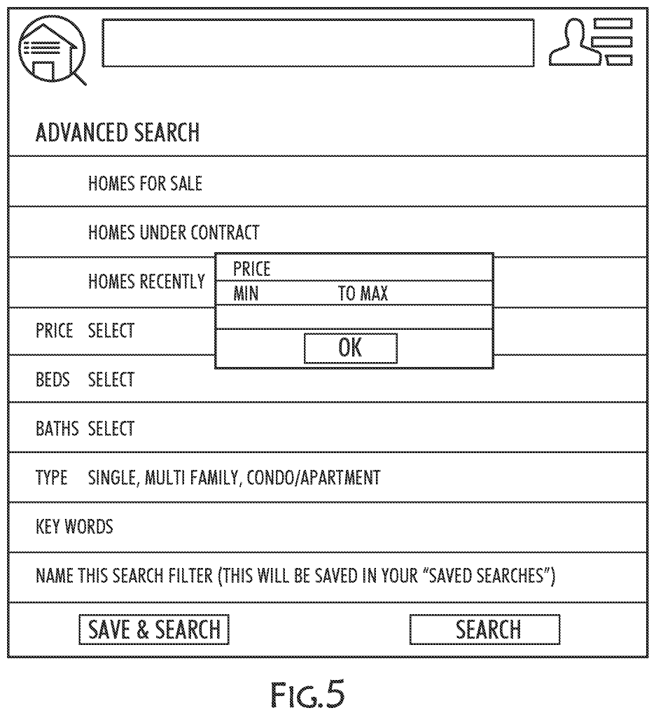

When the user selects “Advanced Search” from the left menu, the screen illustrated in FIG. 5 will appear in the body of the application. The customer can click “Save & Search” (this will save the search criteria to the customers Saved searches or they can simply click “Search.”

Features:

Home for sale

Homes under contract

Homes recently sold

By price

Number of beds

Number of baths

Home type

Key words (features)

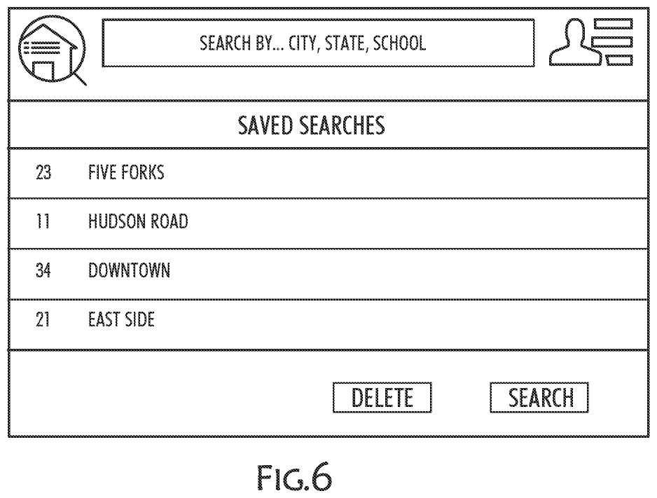

When the user selects “saved searches” from the left menu, the screen of FIG. 6 will appear in the body of the application. The customer can select the previously saved search from the list.

Features:

Displays number of homes in that search criteria

Lists the saved search title

Delete selected saved searches

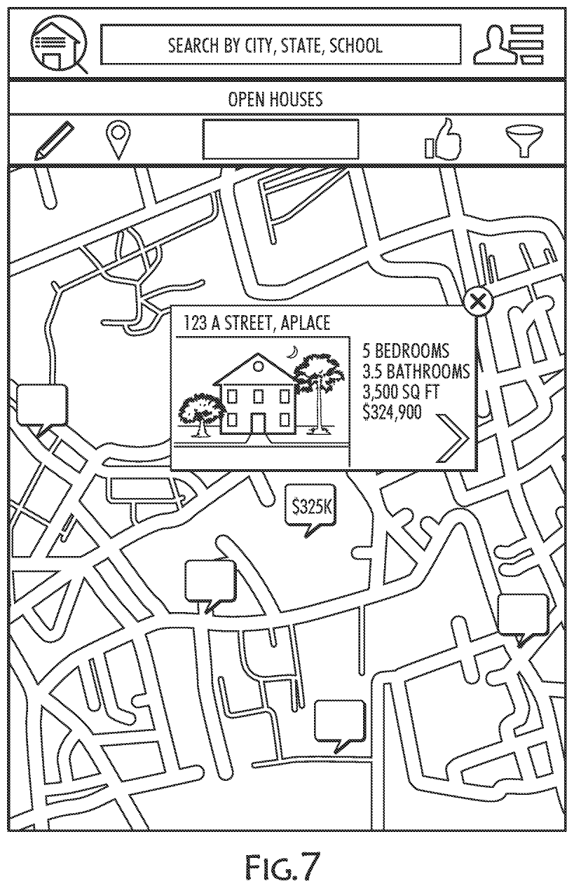

When the user selects “Open Houses” from the left menu, the screen of FIG. 7 will appear in the body of the application. The customer can select one of the Home icons to reveal the details of the home. The customer can search a specific area for Open Houses or they will show the ones in the saved search area(s). The customer can select “open houses” to create a saved “tour” and the app will map them to each home and open files on each home via GPS enabling or manually.

Features:

Address

Main photo

Beds

Baths

Square footage

Price

More Link (right arrow)

Directions

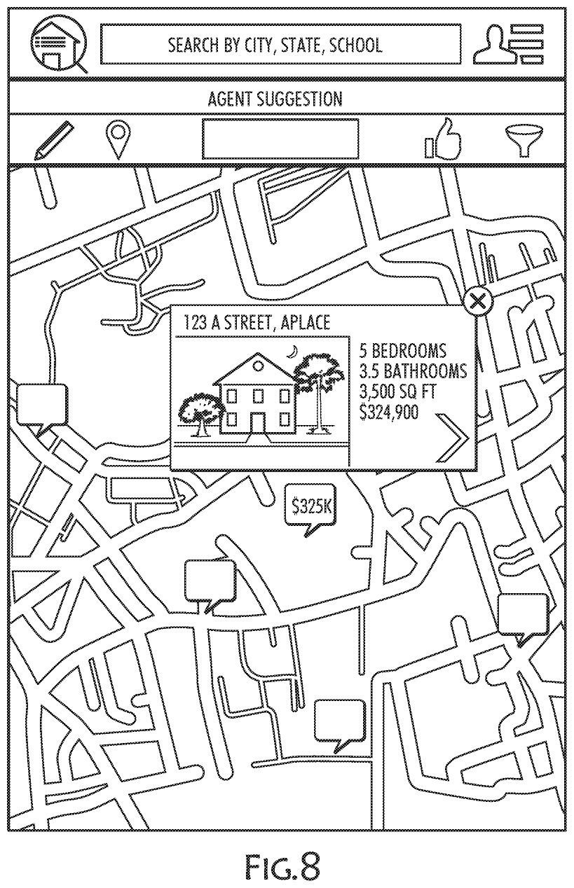

When the user selects “Agent Suggested Homes” from FIG. 8 menu, the screen to the right will appear in the body of the application. The customer can view all the homes their agent has suggested for them to review (map view or list view.)

Features:

Address

Main photo

Beds

Baths

Square footage

Price

More Link (right arrow)

Directions

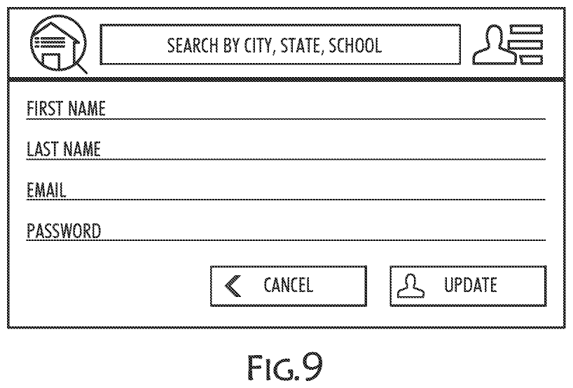

When the user selects “My Profile” from the left menu, the screen of FIG. 9 will appear in the body of the application. The customer can edit their basic information.

Features:

First name

Last name

Email

Password

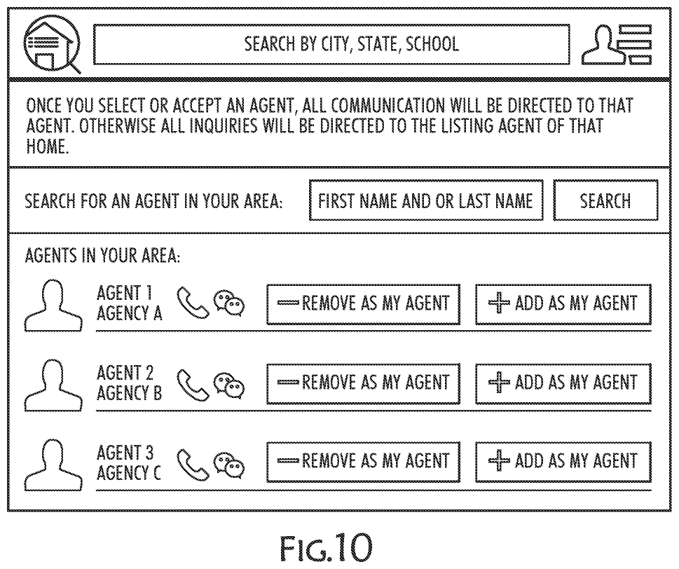

When the user selects “Manage real estate agent” from the left menu, the screen of FIG. 10 will appear in the body of the application. The customer can search for local agents, they can:

Features:

Call

Text

Remove agent

Add agent

When a customer selects an agent as “My Agent” all other agent's names and information will be hidden until or unless the customer removes that agent designated as their agent.

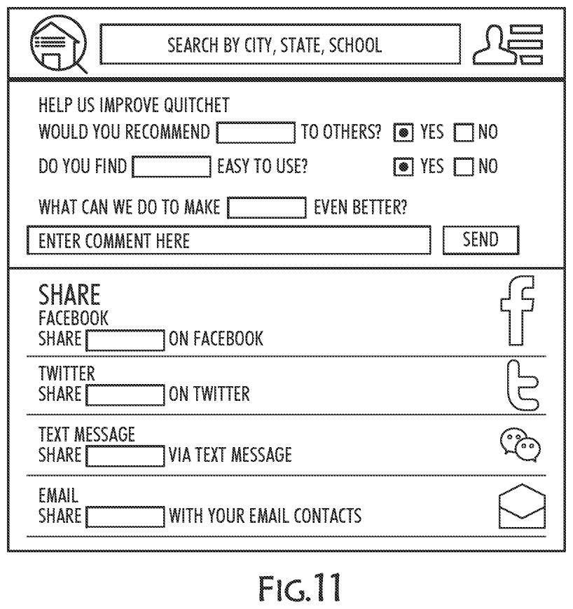

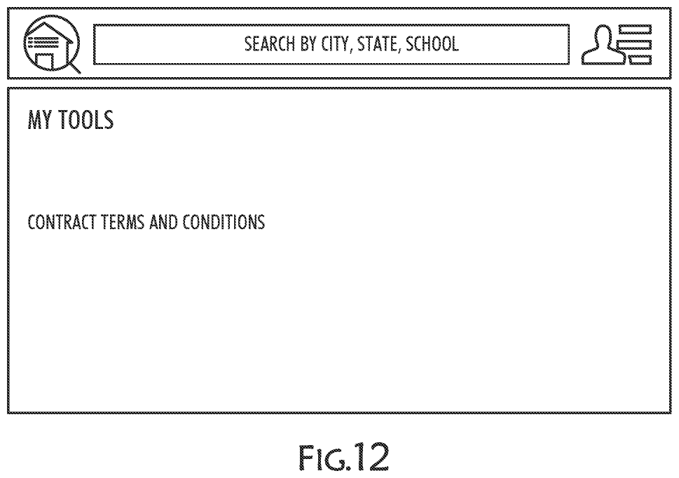

When the user selects “Share” from the left menu, the screen of FIG. 11 will appear in the body of the application. The customer can help us improve the app by leaving us some feedback. They can also share the app with others.

Features:

Improve the app

Facebook

Twitter

Text message

Email

When the user selects “Terms of use” from the left menu, the screen to the right will appear in the body of the application. The customer can read the corporate Terms of Use for the mobile app.

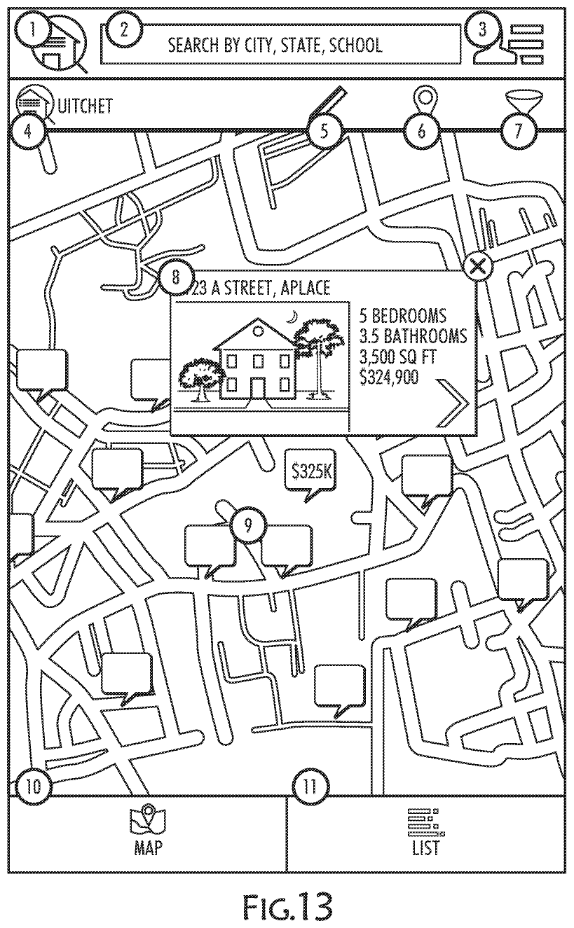

Referring to FIG. 13, the main page of the app is the Map page. This page is having many features for the customer.

### FEATURES BY REFERENCE NUMBER

1. Left icon: By reference number, link to left menu features, search and settings.
2. Quick Search: type in city, state, or school.
3. Right icon: Link to right menu features in My tools.
4. Logo: Link back to main map page.
5. Draw icon: Draw on app the area searches boundaries.
5. Map icon: Searches homes based on customer current location/GPS location.
6. Search icon: Filter homes by for sale, under contract, recently sold, price, beds and baths.
7. Home pop up window: shows basic information about home selected.
8. Map icons: Color coded map icons showing location of homes.
10. Map button: Takes user back to home page (this page).
11. List button: Shows the homes based on the search criteria in a list view.

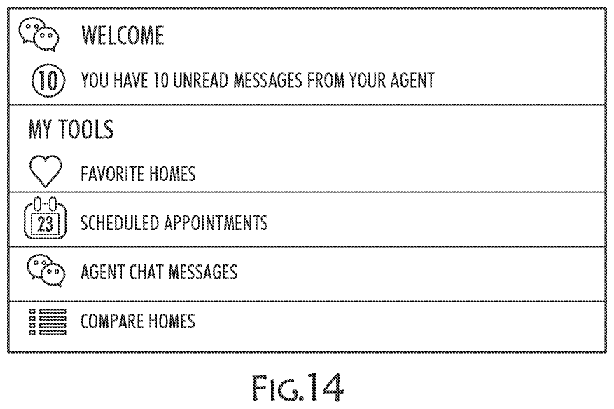

The app has a set of tools designed specifically for the customer. The tools are located on the right slide out menu illustrated in FIG. 14. The following is a list of features found in the right slide out menu.

Features:

Favorite homes

Scheduled appointments

Agent chat messages

Compare homes

The app allows the customer to take any home found in their search results and add/remove them to a “Favorite homes” list. The following is a list of features found in the once a home has been added to the Favorite homes section.

Features:

Images (scroll left and right)

MLS details (scroll up and down)

Remove home from Favorites

Share home with agent

Compare home against other favorite homes

Listed by star rating.

The application allows the customer to request a showing (if they have an agent the request goes to their agent, or if not, the request always goes to the listing/sellers agent). The agent will be notified, once the agent sets the date and time for the showing it will notify the customer and display in Scheduled showings. Once accepted this will populate the customer and agent's calendar.

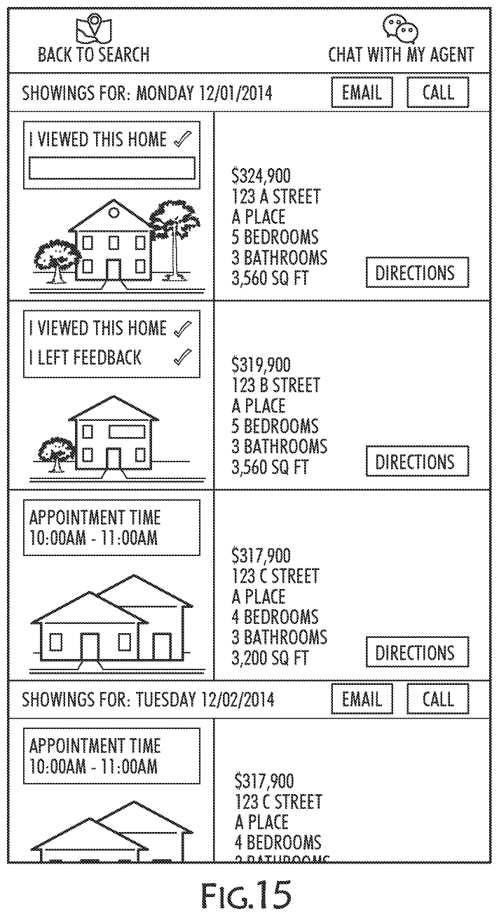

Features as illustrated in FIG. 15:

Back to search

Chat with agent

Directions to the home

Listed showings by date and time

List of past showings

“I viewed the home”

“I left feedback”

The application allows the customer and the associated agent to chat (within the app) around each home. This ensures that all conversation (chats) are grouped and stored within the appropriate home. The Agent chat messages is a list of all the homes that have a chat session. The customer can select the home and review/start or continue a chat dialog. The most recent is always at the top and unanswered chat on each home will be indicated by a bubble icon.

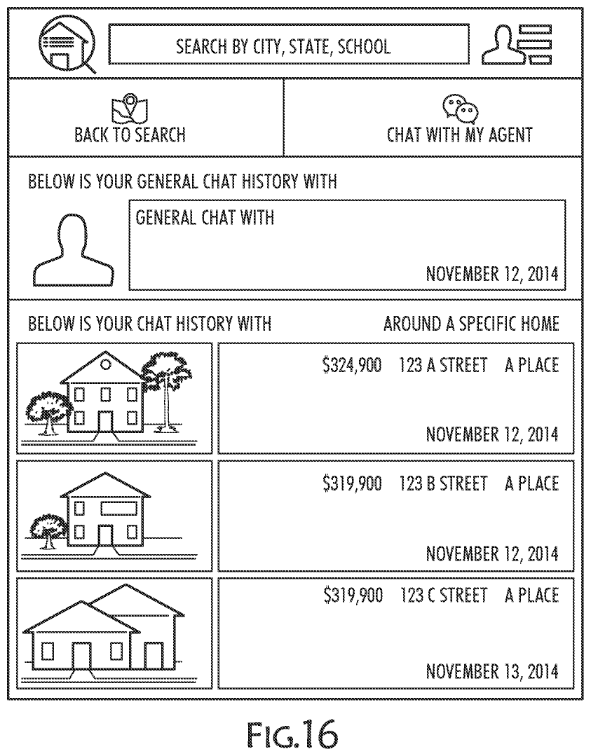

Features (FIG. 16):

Back to search

Chat with agent

List of homes with chat session Separated by general chat with agent and by homes

Once the customer selects a home that has a chat history (see above Agent chat message) they are taken to the actual chat message history.

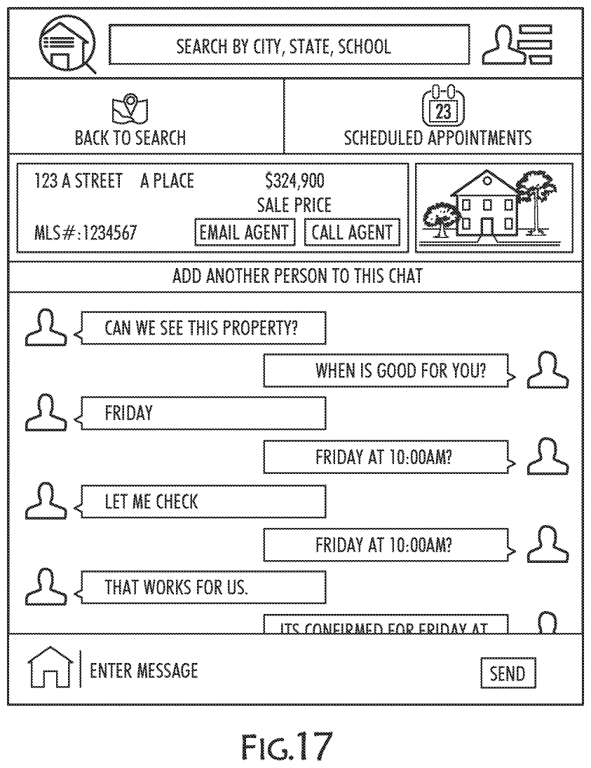

Features (FIG. 17):

Back to search

Schedule a showing

My Files

Add to favorites

Display house details

Email agent

Call agent

Picture of customer and agent

Enter message

Link to Map/Home

The Compare Homes feature allows the customer to select as many homes as they desire from the “Favorite Homes” list. Once the homes are selected and then added to the “Compare Homes” page, the customer can compare all the details side by side with each home.

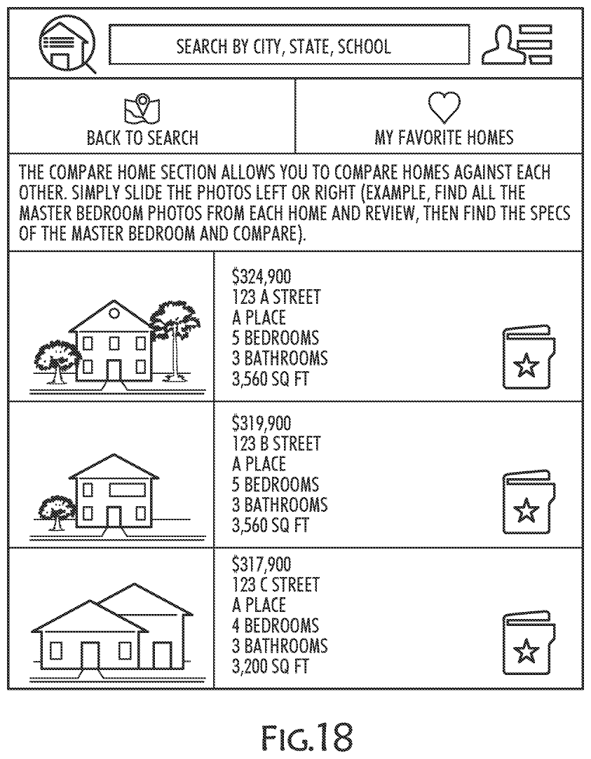

Features (FIG. 18):

Back to search

My favorite homes

Images (slide left and right)

MLS details (slide up and down)

My Files (access all personal images, notes, video, audio, scheduled showing and chat messages).

The Closer Look—Compare Homes feature allows the customer to access all the apps that makeup My Files.

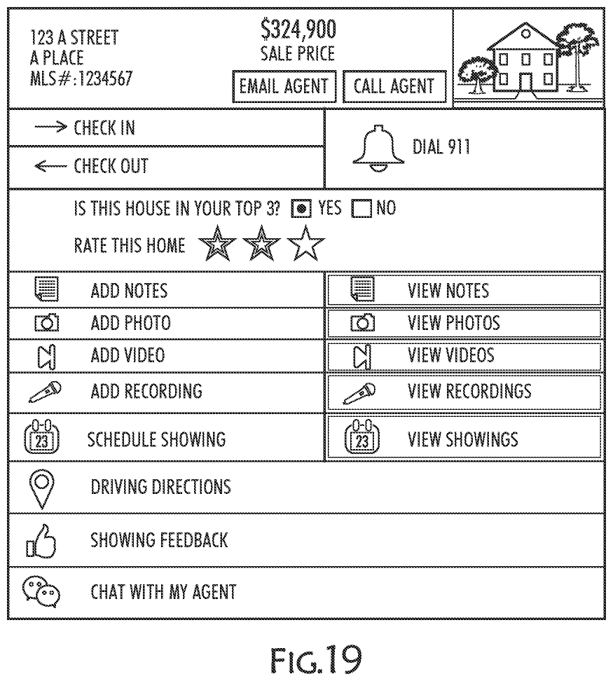

Features (FIG. 19):

Back to search

Home details

Email agent

Call agent

Add/edit notes

Add/edit photos

Add/edit video

Add/edit voice recording

Request showing

Driving directions

Chat with agent

Top 3

Rate this home (3 star)

The Closer Look—Home Details is the main page of all homes in the system. When selected the customer can see all of the MLS details.

Features:

Back to search

Chat with agent

Schedule showing

My Files

Add to Favorites

MLS details

Directions

Email agent

Call agent

The Closer Look—Showing Feedback feature allows the customer to send feedback on the home (after they have visited) back to their showing agent. If they don't have a selected agent it will go directly to the listing agent.

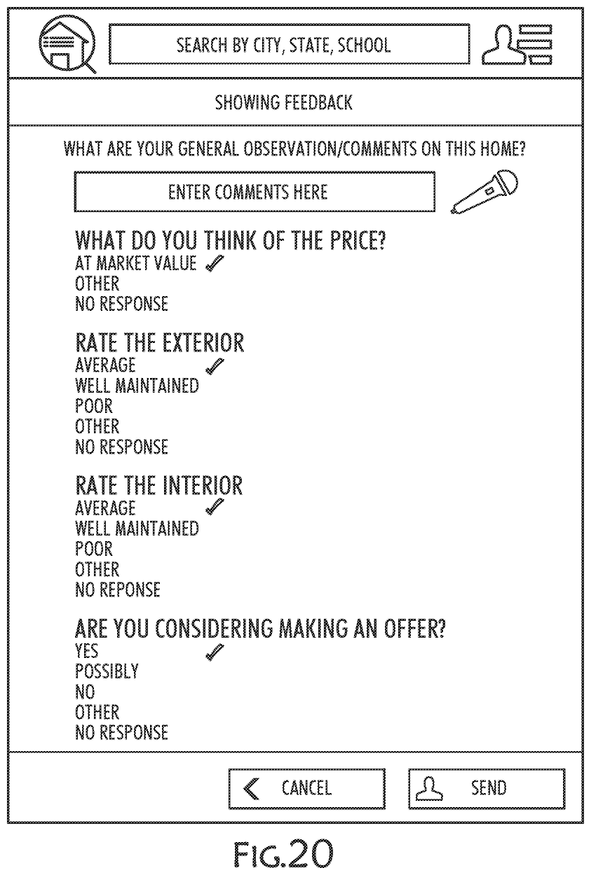

Features (FIG. 20):

Speech or text general comment

Type general comments

Sent to agent via email

Auto updated on Scheduled showing that Feedback was left.

The agent version is designed specifically for the professional agent. The main focus is to give the agent one place to search, communicate with their customers, compare, rank, organize and give feedback on homes. The agent version has all of the features of the customer version but has additional features as described below.

The agent status is the main landing page of the agent version mobile application. The agent has several options once they log in.

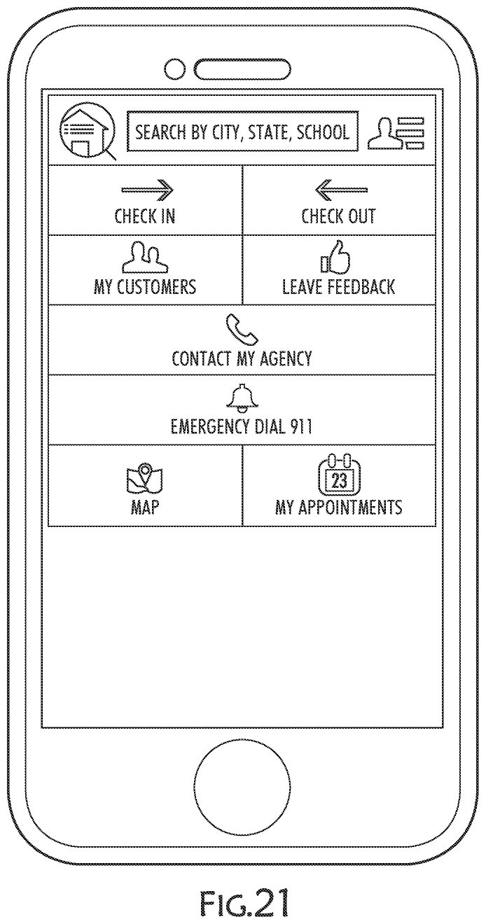

Features (FIG. 21):

Check in to the property

Check out of the property

My customer

Leave feedback

Contact my agency

Dial 911

The agent version can be accessed from a website and or downloaded from iTunes or Google Market Place to the customer mobile device (phone or table).

Agents have access to the customers they are connected with and users who are requesting to be customers. Agents can click the “Favorite homes” next to their customer and access the customers' options. This feature connects the agent and the customer with each and every home added to favorites by the customer.

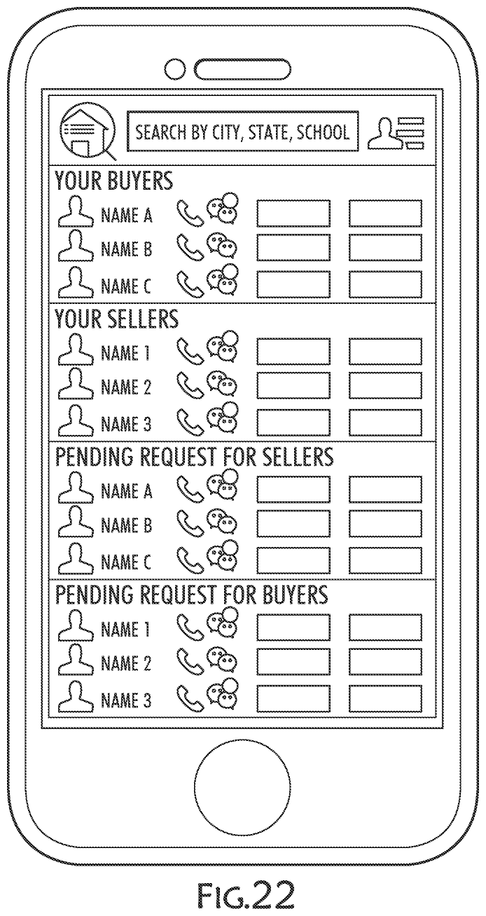

Features (FIG. 22):

Your buyers (remove, connect, share)

Your sellers

Pending buyer user request

Pending seller user request

The agent version can be accessed from a website and/or downloaded from iTunes or Google Market Place or the “Play Store”, as examples, to the customer mobile device (phone or tablet).

The simple search feature searches the MLS database on the agent's search criteria entered (e.g. city and state, zip code, school, address, MLS #). The agent can also search for customers or users based on such things as first name or last name, MLS #, and/or address. The simple search feature is located at the top of the application on all pages throughout the app.

The customer can search based on:

Customer (first or last name)

City and State

School

Zip Code

MLS #

Address

The agent app searches the MLS database based on the agent's search criteria. The agent can then save the search criteria for later use. Once the agent finds the home, they can add to their customers “My Favorites.”

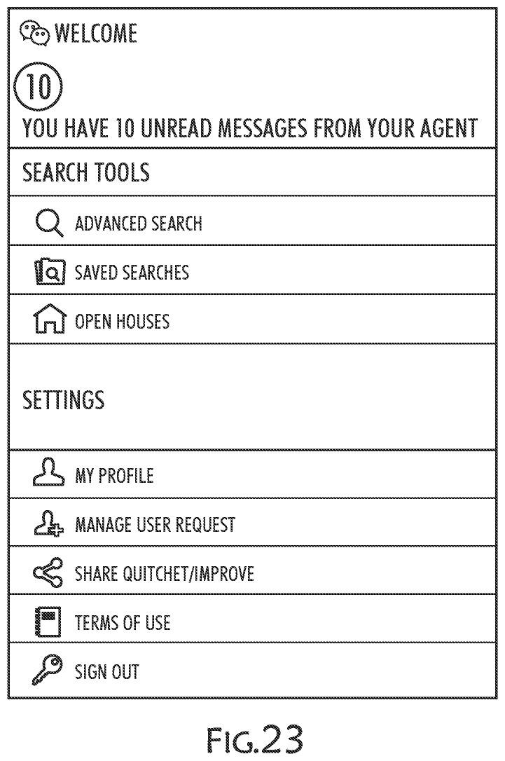

Features (FIG. 23):
iii. Search Tools

Advanced search

Saves searches

Open houses
iv. Settings

My profile

Manager user request

Share Quitchet/Improve Quitchet

Terms of Use

Sign Out

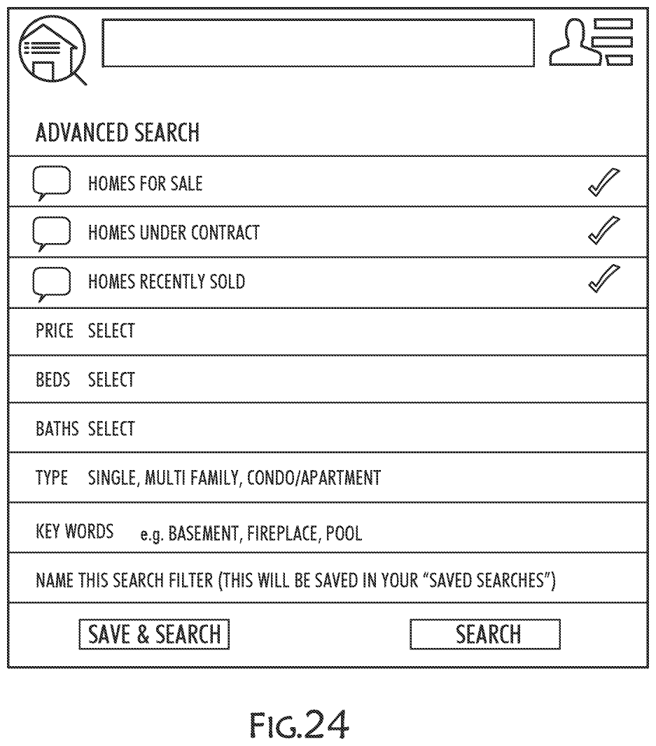

Closer Look—Advanced Search: When the agent selects “Advanced Search” from the menu of FIG. 24, the screen will appear in the body of the application. The agent can set their search criteria and can click “Save & Search” (this will save the search criteria to their Saved searches) or they can simply click “Search.”

Features (FIG. 24):

Home for sale

Homes under contract

Homes recently sold

By Price

Number of beds

Number of baths

Home type

Key words (features)

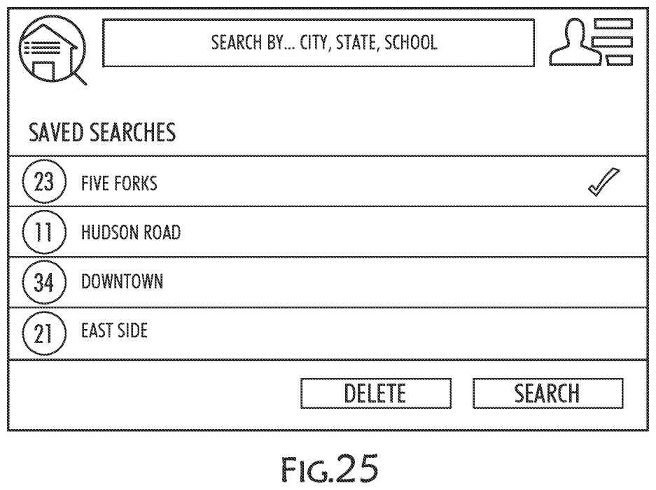

When the agent selects “Saved Searches” from the menu, the screen of FIG. 25 will appear in the body of the application. The agent can select a previously saved search from the list.

Features (FIG. 25):

Displays number of houses in that search criteria

Lists the saved search title

Delete selected saved searches

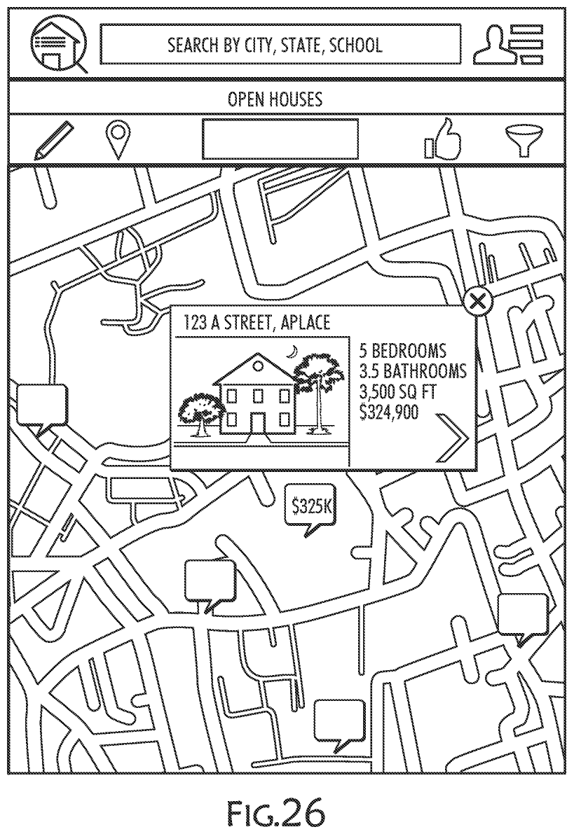

When the agent selects “Open Houses” from the menu, the screen of FIG. 26 will appear in the body of the application. The agent can select one of the Home icons to reveal the details of the home. The agent can search a specific area for Open Houses or they will show the ones in their saved search area(s). The agent can “add an open house” if they wish to schedule one of their listings for a future date and time. The Open House can be added from their listings that are automatically loaded into the app. This will show to all users in the open house search field.

Features (FIG. 26):

Address

Main photo

Beds

Baths

Square foot

Price

More link (right arrow)

Directions

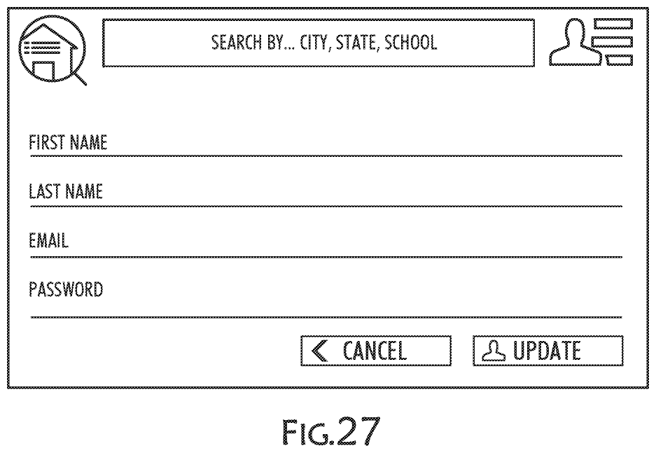

When the agent selects “My Profile” of FIG. 27 from the menu, the screen will appear in the body of the application. The agent can edit their basic information and can also add/edit a full profile visible to all users. A “buyer's packet” can be forwarded to any customer through the app when selected as an agent by a user and accepted by the agent as a customer.

Features (FIG. 27):

First name

Last name

Email

Password

They can also add/edit a full profile visible to all users, add a “buyer's packet” that can be forwarded to any customer via the app when selected as an agent by a user and accepted by app as a customer function.

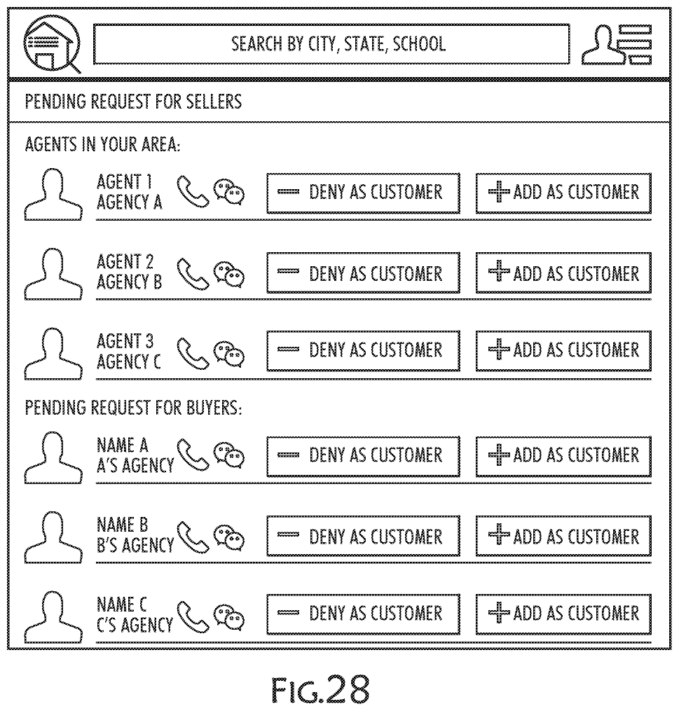

Closer Look—Manager user request: When the agent selects “Manage user request” from the left menu, the screen of FIG. 28 will appear in the body of the application. The agent can manage user request to join as a customer if so desired.

Features (FIG. 27):

Call

Text

Deny as customer

Add as customer

When an agent selects “Add as customer” an email and text will be automatically sent to the user welcoming them as a new customer. This will include the “buyer packet” if created by that agent. The user is then added to the Agent customer (home) screen once they have accepted the invitation. This agent becomes that users “My Agent.”

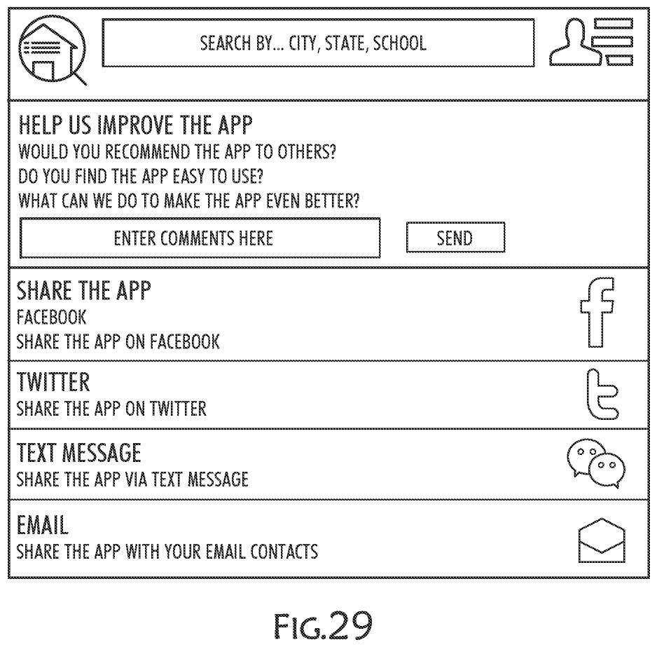

When the agent selects “Share” of FIG. 29 from the left menu, the screen will appear in the body of the application. The agent can help improve the app by leaving feedback. They can also share information with others.

Features (FIG. 29):

Improve this app

Facebook

Twitter

Text Message

Email

When the agent selects “Terms of Use” from the left menu, agent can read the corporate Terms of Use for the mobile app.

When the agent searches for homes in the agent version, the results are displayed in a Map view. The agent has access to several features:

Features List:

Left icon: link to left menu features, search & settings.

Quick Search: type in city, state, or school.

Right icon: link to right menu features in My tools.

Logo: link back to main map page

Draw icon: draw on app the area searches boundaries.

Map icon: searches homes based on customer current location/GPS location.

Search icon: filter homes by for sale, under contract, recently sold, price, beds and baths.

Home pop up window: shows basic information about home selected.

Map icons: color coded map icons showing location of homes.

Map button: takes user back to homepage (this page).

List button: shows the homes based on the search criteria in a list view.

When the agent selects a home from the search results, the details of the home (pulled from MLS) will be displayed. The agent can add this home to their customer(s) “Agent suggested homes” section within the customer app.

Features:

MLS details

Directions

Share with Customers

Image slider

Agent Tools

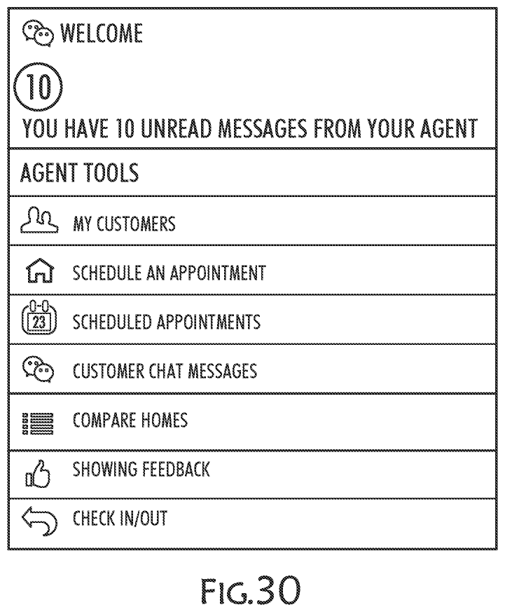

The agent version has a set of agent tools designed specifically for the agent. The tools are located on the right slide out menu (FIG. 30.)

Features:

My customers

Schedule an appointment

Scheduled appointments

Customer chat messages

Compare homes

Showing feedback

Check In/Out

When the agent clicks on “My Customers” the agent has access to the customer and user who is requesting to be a customer. The agent can manage their customers and access each customer “My Favorite Homes.”

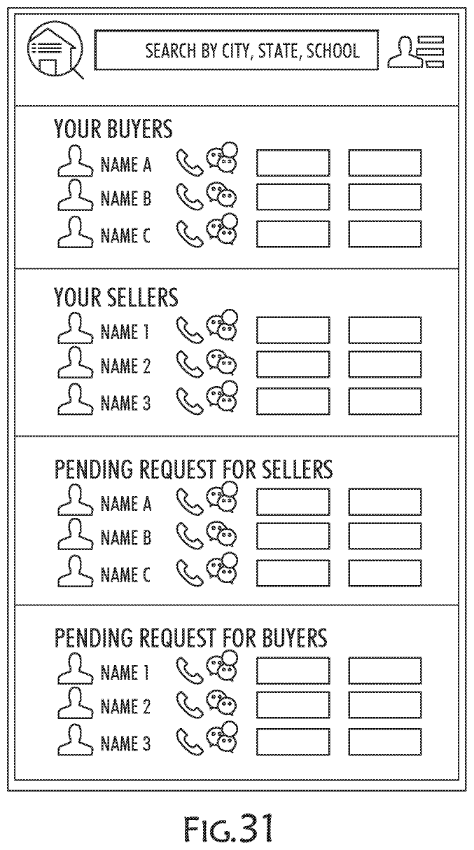

Features (FIG. 31):

Phone

Chat

Remove customers

Add customers

Deny user request

Access Favorite homes (by customer)

Closer Look—Schedule an Appointment

When a customer requests a showing the agent is notified via mobile pop up. The agent can then view all the showing requests grouped by customer. When order is selected all phone appointments are grouped by contact telephone number with time slots noted by each home. The agent can place multiple appointments in order by selecting the first home in the list view and confirming the date and time. They can also be viewed/arranged in map view by touching the map screen. In some embodiments, the app auto schedules base don a formulate that calculates drive time, dwell time in each home (optionally set by the agent) and determines the best arrival time at each home (settable, for example, to the nearest quarter hour). The agent can phone or contact the MLS indicated party (individual or appointment contact company) populated from the MLS information to schedule a showing. The appointment can be expedited through the scheduler of the application connecting with other automated scheduling third-party software, for example. The agent would then confirm the date and starting time and the app would notify customer via the app with the details after the appointment has been confirmed.

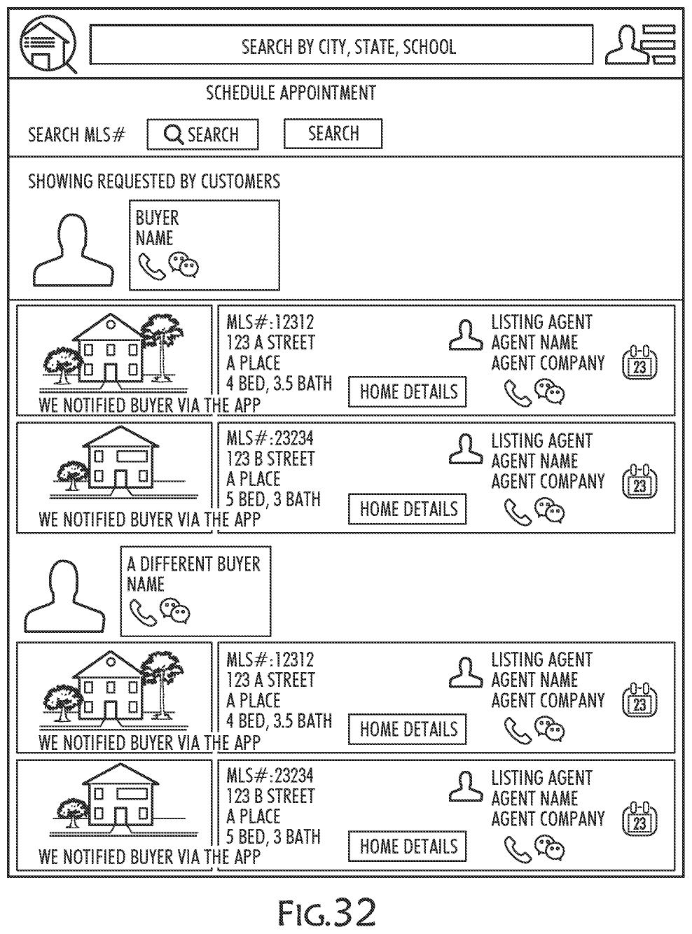

Features (FIG. 32):

Customer information

Home details

Direct text or email chat

Designated contact company or Listing Agent phone, text, email or link
v. to schedule appointment (from MLS data)

Schedule showing

PRO app shows the listing agent contact name and listing number and email in this view and scheduled showing view for ease of contact prior to or during showing session.

When the agent sets the appointment in the app, the application will set the date and time of the appointment in the calendar of agent's customer and the agent opt to send the listing agent and seller an email or text alert/message when arriving and leaving the appointment.

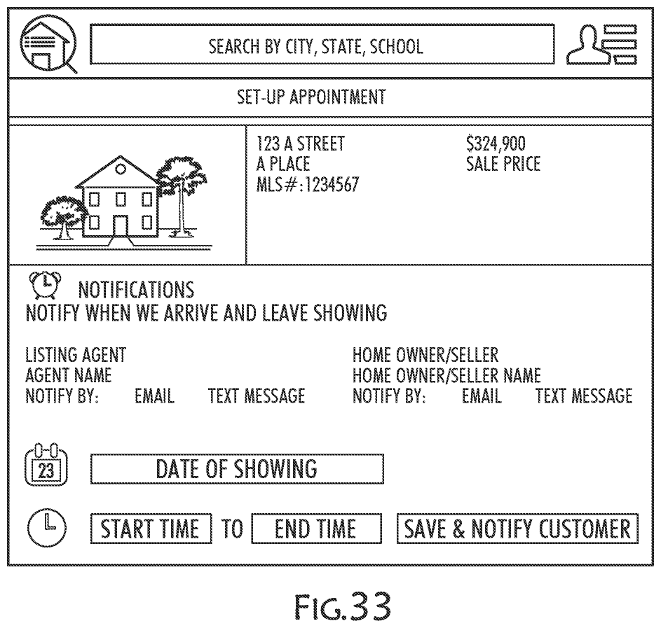

Features (FIG. 33):

Notify seller and listing agent

Set date and time range

The agent can view all scheduled appointments for each customer. Once the agent has scheduled an appointment the agent can export to/view in their mobile calendar on this page.

Features (FIG. 34):

Customer name

Showing date and time

Email customer

Call customer

Directions: (always takes you from your present location if GPS is activated)—if not it will show from your designated “home” start point in your GPS.

MLS details (and image slider)

Check in/Check Out alert or manual function=when the agent arrives at the home, arrival (e.g. as sensed by GPS) will trigger a Detail Page to give options to:

b. View home

c. Enter feedback

d. Check in

e. Check out

f. Emergency alert

The agent version allows the agent to check in and out of a showing.

Check in/Check out alert functions appear when the agent arrives at the home, the arrival (e.g. as sensed by GPS) will go to the Detail Page which gives options to see all or some information about the home, plus a safety timer appears at the bottom of the screen along with a 911 button, for example to call help and/or the agent's brokerage and/or law enforcement with a one touch button.

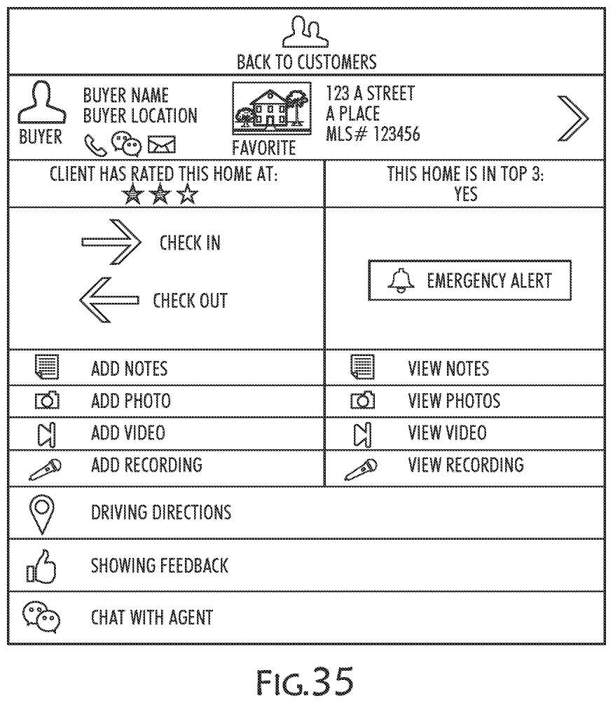

g. (FIG. 35)

My Customers

Contact my agency

Leave feedback

Check in—this button can activate app needed for lock box access

Check out

Emergency alert

Closer look—Customer chat messages

The agent app allows the agent and customers to chat around each home. This ensures that all conversations (chats) are grouped and stored within the appropriate home. The Customer chat message is a list of all the homes that have a chat session. The agent can select the home and review/start or continue a chat dialog. The most recent is always at the top and an unanswered chat on each home will be indicated by a bubble icon.

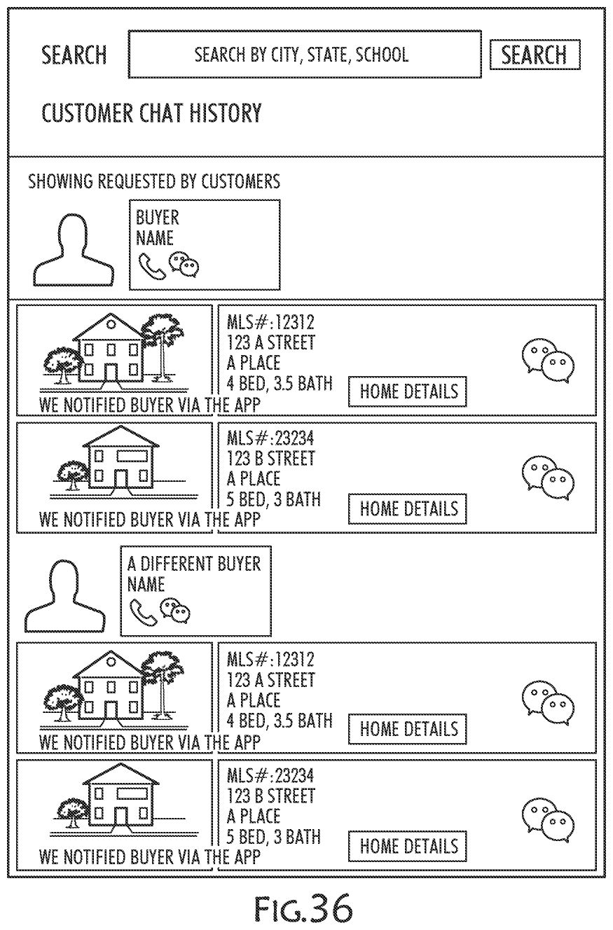

Features (FIG. 36):

Back to search

Chat with customer or agent on each home

List of homes with chat session Separated by general chat with customer and by homes.

Closer Look—Customer Chat—History

Once the agent selects the chat icon on a home (see above) the agent is taken to the chat history between the customer and agent around that home.

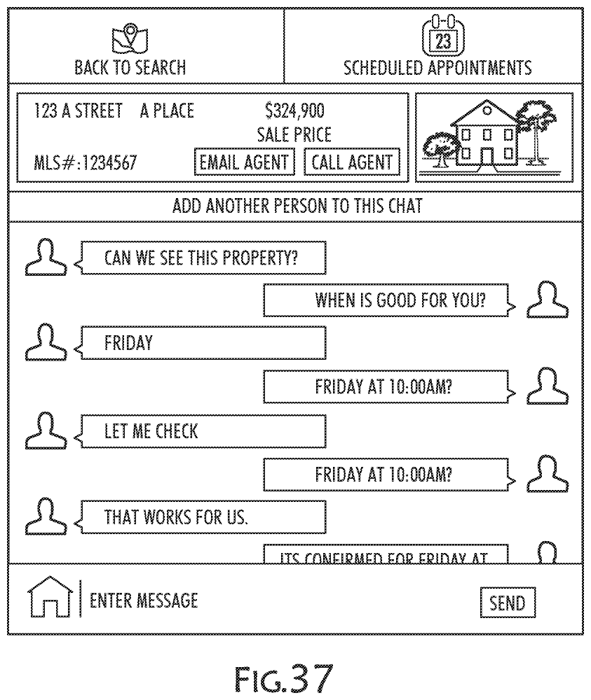

Features (FIG. 37):

Back to search

Schedule a showing

My Favorites

Add to Favorites

Display House Details

Email customer

Call customer

Picture of customer and agent

Enter message

Link to Map/Home

The Compare Homes feature allows the customer to select as many homes as they desire from the “Favorite Homes” list. Once the homes are selected and then added to the “Compare Homes” page the customer can compare all the details side by side for each home.

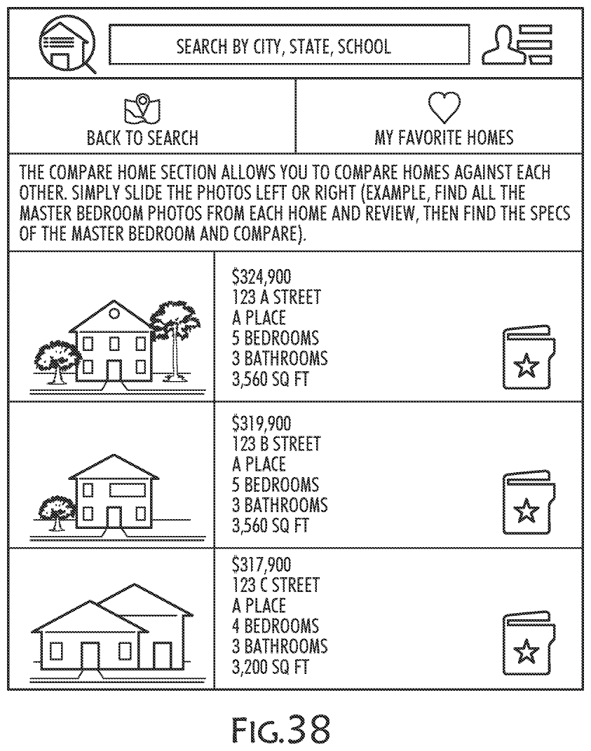

Features (FIG. 38):

Back to search

My Favorite homes

Images (slide left and right)

MLS details (slide up and down)

Home Page (access all personal images, notes, video, audio, scheduled showing and chat messages.)

The Closer Look feature allows the agent to access all the apps that make up the customer version for each customer.

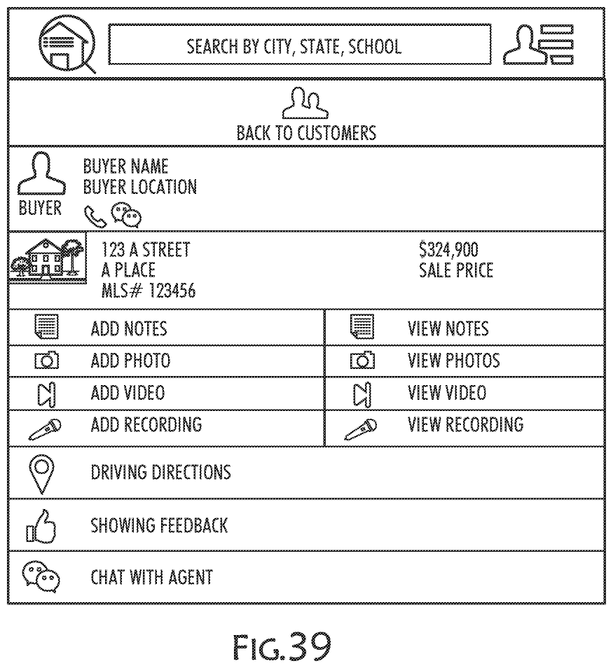

Features (FIG. 39):

Back to search

Home details

Email agent

Call agent

Add/edit notes

Add/edit photos

Add/edit video

Add/edit voice recording

Request showing

Driving directions

Chat with agent

The Closer Look—Showing Feedback—form

This feature allows the agent to complete the feedback based on the comments given to them by the buyer and then send feedback on the home (after they have visited) back to their account to be forwarded later to the listing agent.

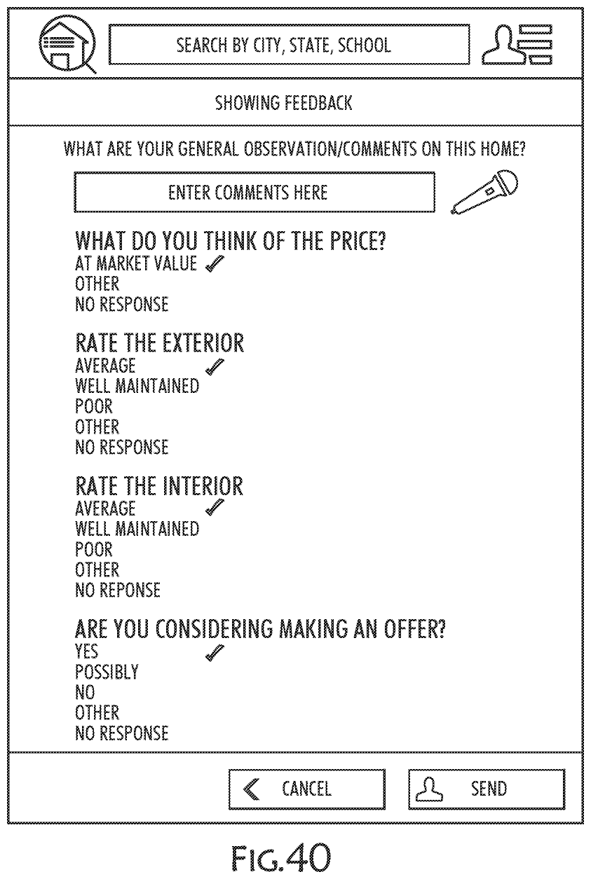

Features (FIG. 40):

Speech to text general comment

Type general comments

Sent to agent via email

Auto updated on Scheduled showing that Feedback was left

The Closer Look—Showing Feedback—Manager

This feature allows the agent to view and send the feedback to the listing agent.

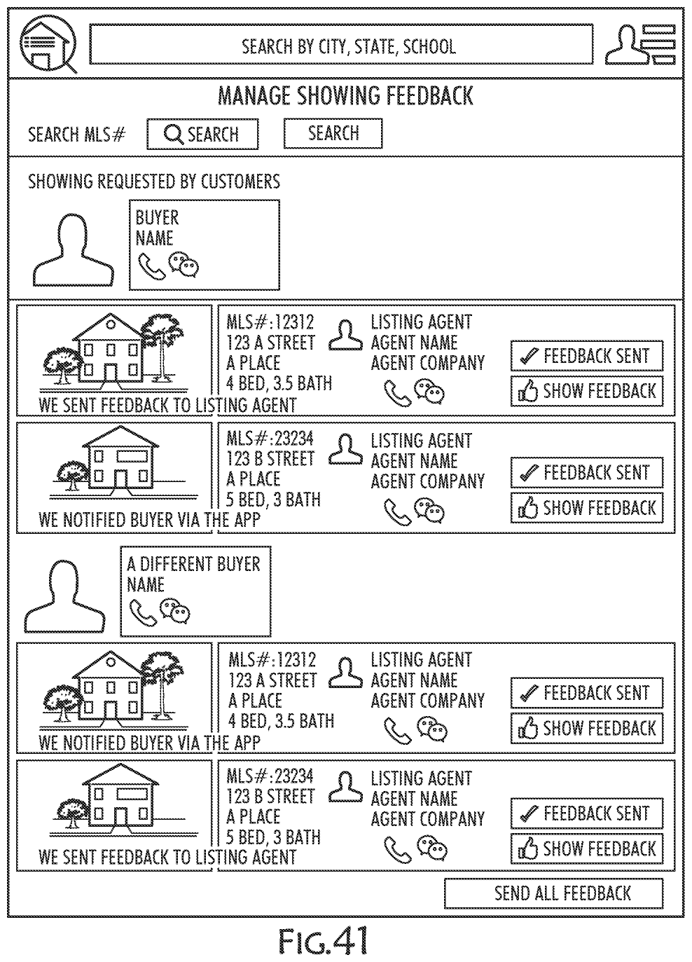

Features (FIG. 41):

Phone or chat with customer

Send feedback to listing agent

Add feedback for customer

Phone, text or email listing agent

There are additional features within the agent version to allow for the schedule of showings through the chat features and link to the listing, setting up schedules, showings and verification through the appropriate contact, either a call or showing center, listing company, listing agent or individual, as designated in the listing information. This can be done by text, email, or hyperlink. After confirmation, it is forwarded to the customer for acceptance and loaded into their calendar.

The agent version also has an additional feature that begins to establish procedures for closing. It allows the agent to schedule inspections, link to inspectors, attorneys, and all other parties involved in the closing process. The agent version has safety features; one feature allows the “safety showing screen” to remain on the agent's screen during the open house. They will check in for the start of the open house and check out when all is clear and they are in their car safely. A “911” button is always up for emergency use. The Agent or the Customer viewing the open house can also complete feedback while viewing the home and send it to the listing agent who can then forward to the seller for completion of the open house. The seller then knows that it is safe to return to the property.

III. The Manager Application

The Manager version is designed specifically for the manager of the agents. The manager can view each agent's scheduled showings. The manager can view the scheduled times, check in and check out status, and how long the agent has been

Agent picture

Phone number/link

Dial 911

Appointment date and time

Address

MLS number

Map link

Customer name and phone number

Check status with time stamp

Check out with time stamp

Timer which stays running until check out

Data gathering to create reports for agents on items such as the number of homes shown until sale, miles traveled, number of customers lost/not converted to sale, etc.

As can be seen from the above description, the systems and methods for managing real estate information described herein represent significantly more than merely using categories to organize, store and transmit information and organizing information through mathematical correlations. The systems and methods for managing real estate information are in fact an improvement to the technology of access control for the premises at which open houses are conducted, as they permit the real estate agents to enter check-in and check-out information regarding the real estate customers at the open houses and to notify a seller that a respective one of the open houses has been concluded. This facilitates the ability of the seller to reenter the premises of that open house sooner and with greater certainty. Moreover, the systems and methods for managing real estate information are confined to residential real estate applications.

One or more currently preferred embodiments have been described by way of example. It will be apparent to persons skilled in the art that modifications and variations are possible without departing from the scope of the claims as purposively construed. In construing the claims, it is to be understood that the use of a computer (including for greater certainty a networked mobile wireless telecommunication computing device) to implement the embodiments described herein is essential.

IV. Compare Home Engine and Image Engine

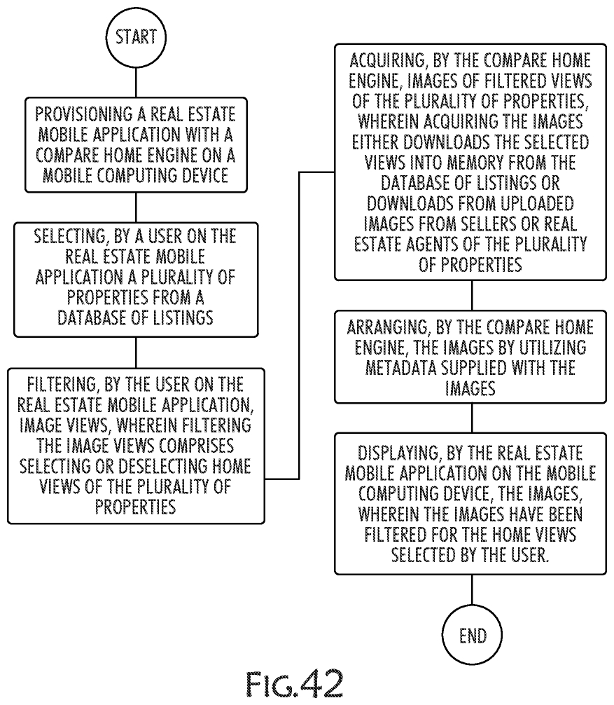

Referring now to FIG. 42, a flow diagram of an example computer implemented method for visually comparing real estate properties within a real estate mobile application. In one aspect a computer-implemented method for comparing real estate properties is disclosed. In the flow diagram the method begins with provisioning a real estate mobile application with a compare home engine on a mobile computing device. In one aspect a compare home engine is a processing engine that handles the downloading, collection, organizing, tagging, and visually arranging or adapting images. In other aspects the compare home engine is embedded with or sits alongside an image engine that works with classifying a database of images and then assigning metadata or tags to images of unknown views. The image engine or the compare home engine may include a content based image retrieval method, wherein use of a convolutional neural network may be applied to classify images. For example, a real estate listing may have images that are missing metadata tags or other tags that identify the image. In one aspect the content based image retrieval will identify aspects, say a sink, or a low hanging fixture and a countertop, it will then perform matching that identifies it as most likely a kitchen. The compare home engine then would tag the image with a kitchen tag and may also place a confidence score. In other aspects, a user may validate, similar to a CAPTCHA the image as being of, in the present example, a kitchen.

Continuing, in the example method, the user selects from the interface on the mobile real estate application at least two, and often times a plurality of seller listings or properties to compare. The listings may originate from an MLS database or other data repository where sellers place residential real estate for sale. Further, the database may even be cached client side or stored on local servers or other repositories. Next, the user filters on the real estate mobile application, wherein filtering assigns or checks boxes that filter for specific views of rooms to compare. For example, a user may select kitchen, dining room, and bathroom, and the compare home engine will acquire images only for those views. The filtering step allows a more granular focus, as real estate listings may have at times 40-50 views, by narrowing down on specific rooms the user is displayed a more relevant search feature. In the filter menu the user may select or deselect views, or may elect all views. Example listing of filters include, kitchen, bathroom, guest bathroom, living room, dining room, pantry, butler's pantry, closet, wardrobe, bedroom, master bedroom, guest bedroom, bedroom closet, garage, outside view, property view, and any other view of a real estate listing as will be known in the art.

Next, the compare home engine acquires images of the filtered views of the plurality of properties selected by the user. It acquires the images through the database of listings as discussed earlier, such as an MLS database. On the MLS database the images may be tagged or metadata attributed for the image such as tagging it with the kitchen tag. In other databases, or even on the MLS, the image may lack a tag or any identifying information. In those images the compare home engine alongside an image engine may attempt to classify the images utilizes a variety of image search, feature extraction, and classification algorithms. Python is one programming language that offers access to libraries such as OpenCV, PIL, Tensorflow, Scikit, and many more that may be used to apply machine learning algorithms on the images for feature extraction and classification. Further, Amazon Web Services™ also offers a suite of capabilities for feature extraction, and image tagging. We will discuss in further one solution, a content based image retrieval process or (CBIR) where we apply a convolutional neural network (CNN) to extract features and a Euclidean distance formulate to query the distance of all images, developing results of images that are similar. In this aspect similar features such as a sink, countertop, cabinets, assist in returning results. Other rooms, such as bedrooms, and living rooms, may have difficulty in assigning, therefore it is contemplated that the compare home engine may have a validation step wherein a user validates the assigned tag. The system and process of validating reinforces the learning model and may also stem into training data sets with known tagged images. The supervised learning process and validation builds additional datasets and increases the training and results of image engine.

In other aspects, other machine learning algorithms may be applied. In one example, a neural network may be applied, or a clustering algorithm such as K nearest neighbor, further a decision tree may also be applied or a support vector machine. Steps may include preprocessing the image to improve feature extraction. Next, it may include detection of objects. Then training on the patterns of detected objects with a labeled training set. Lastly, resulting in classification of the object. This can be done both with supervised training and unsupervised training.

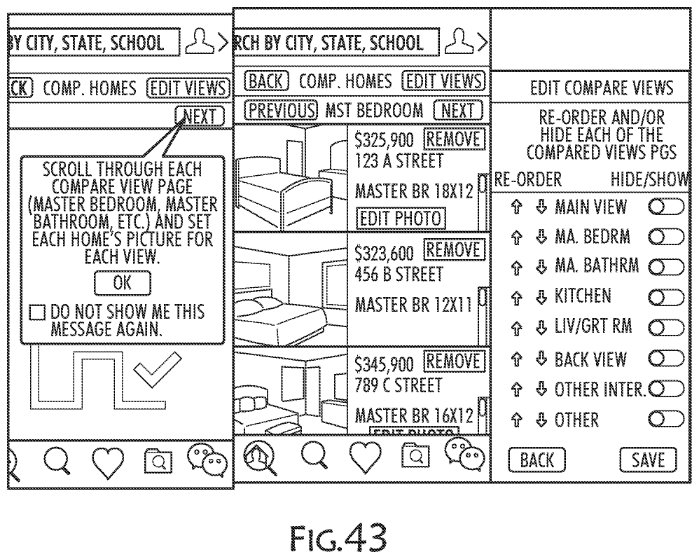

Continuing, the method example of FIG. 42, the compare home engine arranges the images that are tagged or with similar metadata in side by side or list or other format. For example, in FIG. 43 the images are in sequential order each showing an example of a master bedroom. In one aspect, the compare home engine utilizes the already supplied metadata or tags for arranging. In other it utilizes the image engine's classified and tagged images. The arranging of images is a function of the compare home engine tagging and the view available on the mobile computing device. For example, tablet computers or laptops may have wider views or different aspects over mobile phones. Regardless of the aspect the arranging is based on the metadata or tags of the images, wherein a particular view is aligned with comparing properties to allow a user to easily see the same or similar view of a respective property or listing.

Continuing, the real estate mobile application on the mobile computing device displays the results, as in FIG. 43 of the comparison along with useful information such as price and square footage of the room that is being viewed. For images missing metadata and not capable of tagging through the compare home engine and image engine, they may be removed all together or shown to the user wherein a user may supply a tag. This tag may then be reused as data for a training set. In other aspects multiple images may be tagged with “kitchen” or “bathroom,” in such examples the compare home engine may attempt to classify and tag images that are similar based on features. In this aspect the same or similar image may be returned, for example an image of the countertop may be used versus an image of a kitchen with just the sink in view. The compare home engine allows adjustments to feature extraction wherein a layer may be applied in filtering that further narrows selection. For example, under the kitchen filter, the user may select sink, or countertop, or wide view for more granular return of search items. In this aspect the compare home engine becomes an intelligent engine that offers a granular search, and when applied to a plurality of listings allows for easy comparison of many homes or listings.

In other aspects, a computer-implemented method for comparing real estate properties within a real estate mobile application may include provisioning a real estate mobile application with a compare home engine on a mobile computing device such as a laptop, a tablet, or a mobile phone. In said aspect the real estate mobile application executes by moving from long term storage such as an SSD to RAM, wherein the instructions are held for processing by the central processing unit. In the example method, a user selects from a plurality of real estate listings originating from an MLS database. In other examples, any database may be utilized as long as it is accompanied with an xml export support or other format for bringing information into the real estate mobile application. Next, the user filters the image views by selecting or deselecting from the plurality of properties the views in which the user wishes to compare. For example, living room views or dining room views only, or they may select all available views from a list of views populated by the real estate mobile application. Next, the compare home engine may acquire the selected and filtered images by populating them from existing memory or from downloading from an additional database, such as a cloud hosted database or a cached repository. Next, the compare home engine utilizes the image tags or metadata to arrange the images for comparing, wherein the compare home engine may further use objects within the images to place the tags or metadata. For example, a feature extraction algorithm may detect a toilet and a mirror and may return a classification of bathroom to an image that is missing tag or metadata. In other aspects, a feature extraction algorithm may identify a couch and a lamp and return a living room tag. In both aspects a user may validate the tag through the interface or may otherwise be able to check that the image is correct. Lastly, the arranged images are displayed on the user interface of the real estate mobile application. The images are placed in an order to view the selected views that are tagged with the same information to allow viewing properties with only selected views.

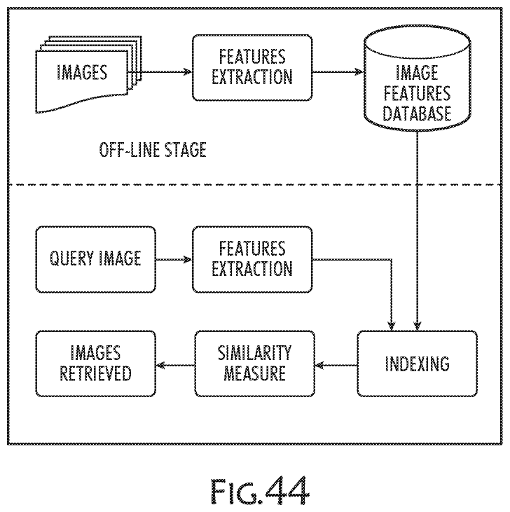

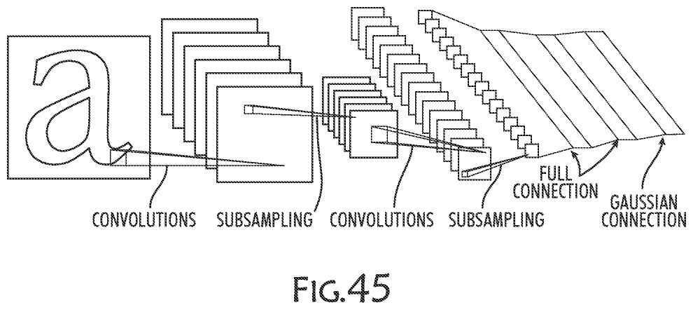

Referring now to FIG. 43, an illustration of an example user interface on a mobile computing device displaying steps in a method for visually comparing real estate properties within a real estate mobile application. In the example the compare home feature is illustrated by showing a compare room view of master bedrooms from a plurality of user selected seller properties or listings. In the example the master bedroom along with other information such as price, and square footage is listed. Other attributes such as listing location, and edit photo exist. Wherein edit photo allows the user to apply a photo from the MLS database or even to upload a photo. Similarly, a seller may be able to upload their own photo or place their own tags or metadata on their listing once it is in a database outside of MLS. For example, a AWS™ cloud database that updates from MLS may allow user customizations through the real estate application as discussed previously herein. A sample workflow may be to take the untagged images and extract features. Then calculate the distance of features between a database of already tagged images. Next, assign a tag to the images that have the closest distance in feature extraction. This algorithm works best when many features are present. In blank rooms or rooms without typical furniture or design patterns the algorithm is expected to lose performance. As a backup to loss in performance a menu for user validation and user input allows the user to Referring now to FIG. 44, a block diagram of an example content based image retrieval. In the example images are pulled from an MLS database for the selected properties and the images are filtered based on the selected views. These images that are already tagged may become supervised training data, and may also be utilized as part of an algorithm for training the compare home engine. In the example, the images are processed through an algorithm to extract features, such as a CNN. A typical CNN workflow is disclosed further in FIG. 45. Another popular algorithm is ORB (Oriented FAST and Rotated BRIEF) developed by OpenCV that functions with keypoints and orientation. In ORB, a given pixel p in an array compares the brightness of p to the surrounding 16 pixels that are in a circle area. Then the pixels are sorted into three classes, lighter than p, darker than p, or similar to p. If more than 8 pixels surrounding p are darker than p, then a keypoint may be designated. This algorithm allows for feature extraction based on key points and is open source. Another example is color gradient histogram, that takes the proportions of color gradients within an image to fine similar color proportions. This algorithm has proven to perform with less reliability due to the complexity involved in rooms that lack many features or colors. There are other feature extraction algorithms that may be applicable and it is contemplated that the use of one over the other is a choice that may be selected based on optimization over training sets.

Continuing with FIG. 44, the image features database is then indexed and utilized with a similarity measure, such as Euclidean distance or other distance factoring algorithm. The images that are tagged or listed with metadata are then retrieved. The query image or untagged image is compared to the tagged image and the untagged image is assigned the same label as the closest tagged image based on features. Thus, for feature extraction to perform the selected algorithm must be able to discern features, including features in rooms that may lack interior design or objects that may be commonly associated with a particular room.

Referring now to FIG. 45, an illustration of an example convolutional neural network (CNN) algorithm for feature extraction. A CNN is but one example of an algorithm that may be applied for feature extraction. A CNN is considered a deep learning algorithm which can take an input image, assign importance (weights and biases) to various objects in the image, and then differentiate it from other images. CNN's benefit from having minimal preprocessing requirements, allowing the present disclosure to benefit from acquiring images directly from a database, such as an MLS database and having minimal requirements for preprocessing. A CNN is often analogous to the connectivity pattern of neurons in a brain. The steps involved may begin with preprocessing, and then advance to a convolution layer, often referred to as the kernel or filter. Next, the pooling layer for reducing spatial size of the convolved feature. This may be done with max pooling or average pooling. Further, in max pooling a noise suppressant may also be applied. Lastly, a classification layer or a fully connect classification layer as a way of learning non-linear combinations of high level features. There are various architectures for CNN's, such as LeNet, AlexNet, VGGNet, GoogLeNet, ResNe, and ZFNet to name a few.

Modifications, additions, or omissions may be made to the systems, apparatuses, and methods described herein without departing from the scope of the disclosure. For example, the components of the systems and apparatuses may be integrated or separated. Moreover, the operations of the systems and methods disclosed herein may be performed by more, fewer, or other components and the methods described may include more, fewer, or other steps. Additionally, steps may be performed in any suitable order. As used in this document, “each” refers to each member of a set or each member of a subset of a set.

1. A computer-implemented method for visually comparing real estate properties, comprising:
provisioning a real estate mobile application with a compare home engine on a mobile computing device;
selecting, by a user on the real estate mobile application a plurality of properties from a database of listings;
filtering, by the user on the real estate mobile application, image views, wherein filtering the image views comprises selecting or deselecting home views of the plurality of properties;
acquiring, by the compare home engine, images of filtered views of the plurality of properties, wherein acquiring the images either downloads the selected views into memory from the database of listings or downloads from uploaded images from sellers or real estate agents of the plurality of properties;
arranging, by the compare home engine, the images by utilizing metadata supplied with the images; and
displaying, by the real estate mobile application on the mobile computing device, the images, wherein the images have been filtered for the home views selected by the user.

2. The method of claim 1, further comprising identifying, by the compare home engine, missing metadata.

3. The method of claim 2, further comprising assigning, by the compare home engine, metadata by the compare home engine executing an image engine that classifies the images with various home views.

4. The method of claim 3, wherein classifying the images with the home views, attributes a home view to the image, of at least a kitchen view or a living room view.

5. The method of claim 1, further comprising removing, by the compare home engine, the images with missing metadata.

6. The method of claim 1, wherein selecting by the real estate mobile application, the plurality of properties from the database of listings, further selects the plurality of properties from an MLS database.

7. The method of claim 1, wherein arranging the images places tags or information on the images with similar metadata.

8. The method of claim 1, wherein displaying the images places the images with matching metadata side by side for comparison.

9. A computer-implemented method for visually comparing real estate properties within a real estate mobile application, comprising:
provisioning a real estate mobile application with a compare home engine on a mobile computing device;
executing the real estate mobile application, wherein executing moves a stored version to RAM on the mobile computing device;
selecting, by a user on the real estate mobile application a plurality of properties from an MLS database of listings;
filtering, by the user on the real estate mobile application, image views, wherein filtering the image views comprises selecting or deselecting image views of the plurality of properties;
acquiring, by the compare home engine, images of filtered views of the plurality of properties, wherein acquiring images either downloads the selected views into memory from the MLS database of listings or downloads from a database of user hosted images;
arranging, by the compare home engine, the images by utilizing metadata supplied with the images and identifying visual objects by an image engine; and
displaying, by the real estate mobile application on the mobile computing device, the images, wherein the images have been filtered for the home views selected by the user.

10. The method of claim 9, further comprising identifying, by the compare home engine, missing metadata.

11. The method of claim 10, further comprising assigning, by the compare home engine, metadata by the compare home engine executing an image engine that classifies images with various home views.

12. The method of claim 11, wherein classifying the images with the home views, attributes a home view to the image, of at least a dining room view or a bedroom room view.

13. The method of claim 9, further comprising removing, by the compare home engine, the images with missing metadata.

14. The method of claim 9, wherein selecting by the real estate mobile application, the plurality of properties from the database of listings, further selects the plurality of properties from an MLS database.

15. The method of claim 9, wherein arranging the images places tags or information on images with similar metadata.

16. The method of claim 9, wherein displaying the images places the images with matching metadata side by side for comparison.
